(19) United States
(12) Patent Application Publication
(10) Pub. No.: US 2014/0122777 A1
(43) Pub. Date: May 1, 2014

(54) FLASH MEMORY CONTROLLER HAVING MULTI MODE PIN-OUT

(71) Applicant: MOSAID TECHNOLOGIES INCORPORATED, Ottawa (CA)

(72) Inventors: HakJune OH, Ottawa (CA); Jin-Ki KIM, Ottawa (CA); Young Goan KIM, Seoul (KR); Hyun Woong LEE, Seoul (KR)

(73) Assignee: MOSAID TECHNOLOGIES INCORPORATED, Ottawa (CA)

(21) Appl. No.: 13/836,113

(22) Filed: Mar. 15, 2013

Related U.S. Application Data
(60) Provisional application No. 61/720,652, filed on Oct. 31, 2012.

(51) Int. Cl. G06F 3/06

(52) U.S. Cl. CPC G06F 3/0661; G06F 3/061; G06F 3/0679
USPC 711/103

(57) ABSTRACT

A memory controller of a data storage device which communicates with a host, has channel control modules each being configurable to have at three different pinout assignments for interfacing with two different types of memory devices operating with different memory interface protocols. One pinout assignment corresponds to a memory interface protocol where memory devices can be connected in parallel with each other. Two other pinout assignments correspond respectively to inbound and outbound signals of another memory interface protocol where memory devices are serially connected with each other. In this mode of operation, one channel control module is configured to provide the outbound signals while another channel control module is configured to receive the inbound signals. Each memory port of the channel control modules includes port buffer circuitry configurable for different functional signal assignments. The configuration of each channel control module is selectable by setting predetermined ports or registers.

### CROSS REFERENCE TO RELATED APPLICATIONS

This application claims the benefit of U.S. Provisional Patent Application No. 61/720,652, filed on Oct. 31, 2012, which is hereby incorporated by reference.

### FIELD

The present disclosure relates generally to memory systems. More particularly, the present application relates to non-volatile memory controllers.

### BACKGROUND

Today, many electronic devices include memory systems that are used to store information (data) utilized by the devices. For example, some digital audio players include memory systems that are used to store digitized audio that may be played by the players. Likewise, personal computer systems often employ memory systems to store software utilized by the computer systems.

In many electronic devices, memory systems often comprise a controller and one or more memory devices. The controller typically contains circuitry configured to generate signals that are used to direct the memory devices to store and retrieve information. The memory devices typically store the information in memory that is contained in the memory devices. The memory may be volatile or non-volatile. A memory device that contains volatile memory often loses the stored information when power is removed from the device. A memory device containing non-volatile memory often retains the stored information even when power is removed from the device.

In certain conventional memory systems, data and control signals are transferred between the controller and memory devices in parallel using a parallel bus. Often, many wires are used to implement the bus and, depending on the layout of the memory system, the wires may extend for some length.

Electronic equipment uses semiconductor devices, such as, for example, memory devices. Memory devices may include random access memories (RAMs), flash memories (e.g., NAND flash device, NOR flash device), and other types of memories for storing data or information. Memory devices can be combined to form as a storage device (e.g., a solid state drive (SSD)).

### SUMMARY

According to a first aspect of the present disclosure, there is provided a multi function memory controller. The multi function memory controller includes channel control modules and a host interface. The channel control modules each have at least one memory interface port including circuitry configurable to buffer a first signal compatible for communicating in a first memory interface protocol, a second signal compatible for communicating in a second memory interface protocol different than the first memory interface protocol or a third signal compatible for communicating in the second memory interface protocol. The host interface has host interface ports for communicating information between a host device and the memory interface.

According to an embodiment of the first aspect, each of the channel control modules includes a first mode select port selectively connectible to either a first voltage or a second voltage, and a second mode select port selectively connectible to either the first voltage or the second voltage independently of the first mode select port. The at least one memory interface port of all of the channel control modules are configured to buffer the first signal compatible for communicating in the first memory interface protocol. The first mode select port and the second mode select port are connected to a first pre-defined combination of the first voltage and the second voltage for configuring all of the channel control modules to buffer the first signal. In this embodiment, a first channel control module is configured to buffer the second signal for communicating in the second memory interface protocol and a second channel control module is configured to buffer the third signal for communicating in the second memory protocol. The first mode select port and the second mode select port of the first channel control module are connected to a second pre-defined combination of the first voltage and the second voltage different from the first pre-defined combination, and the first mode select port and the second mode select port of the second channel control module are connected to a third pre-defined combination of the first voltage and the second voltage different from the first pre-defined combination and the second pre-defined combination.

In another embodiment of the first aspect, a first channel control module is configured to buffer the second signal for communicating in the second memory interface protocol and a second channel control module is configured to buffer the third signal for communicating in the second memory protocol, where the second signal is an outbound signal and the third signal is an inbound signal. In this embodiment, the first channel control module is configured to buffer only outbound signals for communicating in the second memory interface protocol, and the second channel control module is configured to buffer only inbound signals for communicating in the second memory interface protocol. The first memory interface protocol is an ONFi memory interface protocol, and the second memory interface protocol is an HLNAND memory interface protocol.

In a second aspect, there is provided non-volatile memory system including a memory controller and a memory device. The memory controller includes channel control modules each having ports configurable to buffer first signals corresponding to a first memory interface protocol, second signals corresponding to a second memory interface protocol, and third signals corresponding to the second memory interface protocol. The memory device is operable in one of the first memory interface protocol and the second memory interface protocol in communication with one of the channel control modules. According to an embodiment of the second aspect, each of the channel control modules includes a first mode select port selectively connectible to either a first voltage or a second voltage, and a second mode select port selectively connectible to either the first voltage or the second voltage independently of the first mode select port. For the first memory interface protocol, the memory device includes at least two memory chips connected in parallel to the ports of a channel control module. The first memory interface protocol can be an ONFi memory interface protocol.

In the embodiment where the memory device includes at least two memory chips connected in parallel to the ports of a channel control module in the first memory interface protocol, the second signals are outbound signals and the third signals are inbound signals. In this embodiment, a first channel control module is configured to buffer the outbound signals and a second channel control module is configured to buffer the inbound signals of the second memory interface protocol. For the second memory interface protocol, the memory device includes at least two memory chips connected in series in a ring topology configuration with the first channel control module and the second channel control module. The second memory interface protocol can be an HLNAND memory interface protocol.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a block diagram of a memory system to which embodiments of the present disclosure are applied;

FIG. 2A is a block diagram showing functional pinouts of a first type of memory controller;

FIG. 2B is a block diagram showing functional pinouts of a second type of memory controller;

FIG. 3A is schematic showing a multi-drop memory system;

FIG. 3B is schematic showing a serially connected memory system;

FIG. 4 is a block diagram of solid state storage device using a multi function memory controller, according an embodiment of the present disclosure;

FIG. 5 is a block diagram of a memory interface block of the multi function memory controller shown in FIG. 4, according to an embodiment of the present disclosure;

FIG. 6 is a block diagram of a multi-drop bus architecture memory system using a multi function memory controller, according to an embodiment of the present disclosure;

FIG. 7 is a block diagram of a serial point-to-point architecture memory system using a multi function memory controller, according to an embodiment of the present disclosure;

FIG. 8 is a schematic showing an example of the multi-drop bus architecture memory system of FIG. 6, according to an embodiment of the present disclosure;

FIG. 9 is a schematic showing an example serial point-to-point architecture memory system, according to an embodiment of the present disclosure;

FIG. 10 is a block diagram of a channel control module of the memory interface block shown in FIGS. 7 and 10, according to an embodiment of the present disclosure;

FIG. 11 is an illustration of pinout mappings of signals to ports of the multi function channel control module, according to an embodiment of the present disclosure;

FIG. 12 is a circuit schematic of a mode selection interface circuit, according to an embodiment of the present disclosure;

FIG. 13 is a circuit schematic of a multi mode bi-directional interface circuit, according to an embodiment of the present disclosure;

FIG. 14 is a circuit schematic of a multi mode bi-directional interface circuit, according to an embodiment of the present disclosure;

FIG. 15 is a circuit schematic of a multi mode output interface circuit, according to an embodiment of the present disclosure; and,

FIG. 16 is a circuit schematic of an alternate multi mode bi-directional interface circuit, according to an embodiment of the present disclosure.

### DETAILED DESCRIPTION

Generally, the embodiments of the present disclosure provides a memory controller of a data storage device which communicates with a host, having channel control modules each being configurable to have at three different pinout assignments for interfacing with two different types of memory devices operating with different memory interface protocols. One pinout assignment corresponds to a memory interface protocol where memory devices can be connected in parallel with each other. Two other pinout assignments correspond respectively to inbound and outbound signals of another memory interface protocol where memory devices are serially connected with each other. In this mode of operation, one channel control module is configured to provide the outbound signals while another channel control module is configured to receive the inbound signals. Each memory port of the channel control modules includes port buffer circuitry configurable for different functional signal assignments. The configuration of each channel control module is selectable by setting predetermined ports or registers.

Flash memory is a commonly used type of non-volatile memory in widespread use as mass storage for consumer electronics, such as digital cameras and portable digital music players for example. Such flash memory take the form of memory cards or universal serial bus (USB) type memory sticks, each having at least one memory device and a memory controller formed therein. Another mass storage application is solid state drives (SSD) which can be used as replacements for computer hard disk drives. These solid state drives can be used in computer workstations, networks, and for virtually any application in which large amounts of data need to be stored.

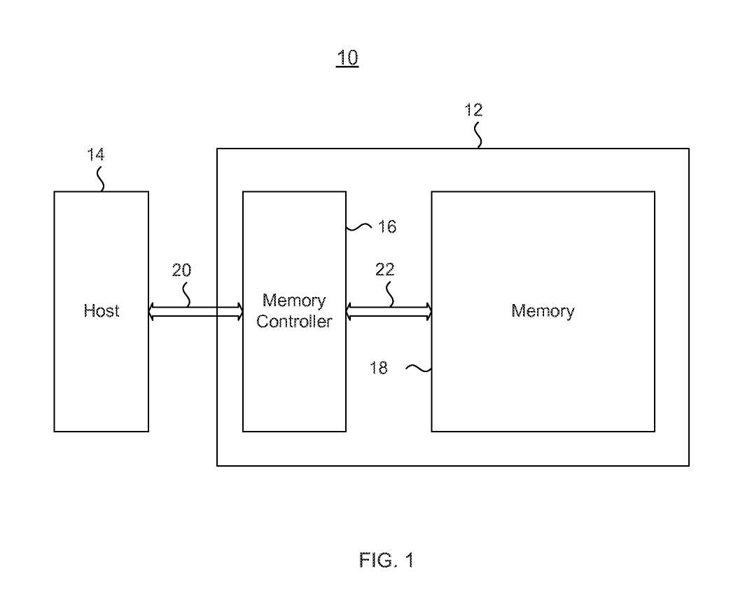

FIG. 1 depicts a system, such as, for example, a non-volatile memory system to which embodiments of the present disclosure are applied. Referring to FIG. 1, a non-volatile memory system 10 includes data storage device 12 and a host 14 as an external device or apparatus. A non-limiting example of the data storage device 12 is a solid state drive (SSD). A non-limiting example of the host 14 is a computer or other computing system.

The data storage device 12 includes a memory controller 16 and memory 18. The memory 18 includes volatile memory devices, or non-volatile memory devices such as, for example, flash memory devices. The memory 18 may include a traditional rotating magnetic storage disk. The host 14 is coupled with the data storage device 12 via an interface protocol bus 20 and communicates with the memory controller 16 using an interface protocol. The interface protocol includes, for example, the peripheral component interconnect-express (PCI-E) protocol, advanced technology attachment (ATA) protocol, serial ATA (SATA) protocol, parallel ATA (PATA) protocol, or serial attached SCSI (SAS) protocol. However, the interface protocol between the host 14 and the data storage device 12 is not restricted to the above examples and may include other interface protocols, such as universal serial bus (USB) protocol, multi-media card (MMC) protocol, enhanced small disk interface (ESDI) protocol, integrated drive electronics (IDE) protocol or the like. The interface protocol bus 20 transfers data and commands between the host 14 and the memory controller 16, and has the form of pins, ports and other physical interfaces. The data storage device 12 may have any type of form factor, including a conventional HDD (Hard Disk Drive) form factor, PCIe PCB card form factor, plug-in module (e.g. DIMM) form factor or in a portable memory card (e.g., a secure digital (SD) card or an MMC) form factor, for example.

The memory 18 includes at least one NAND flash memory device, for example, but is not limited to NAND flash memory in this illustrative configuration. The memory 18 may include phase-change random access memory (PCRAM), magneto-resistive RAM (MRAM), resistive RAM (ReRAM), ferroelectric RAM (FeRAM), or other types of memories. When the memory 18 is a flash memory device, it may be a NAND flash memory device using floating-gate technology or charge trap flash (CTF) technology, for example.

The memory controller 16 is coupled with a memory protocol bus 22. The memory controller 16 includes an interface for communicating commands and data with the memory 18 using a memory protocol. Depending on the specific type of memory being used as memory 18 in data storage device 12, a specific protocol native to the specific type of memory is used. Accordingly, the memory controller 16 is configured to communicate with the memory 18 using the specific protocol dictated by the type of memory 18 being used. For example, each of the different types of previously mentioned non-volatile memories may have a different communication protocol, in which command operation codes may differ, the types of control signals may differ, and the data format may differ. In short, the communication protocols of different memories are incompatible with each other. Therefore, different memory controllers are required for interfacing with different types of memory 18 used in the data storage device 12. The cost for manufacturers of data storage device 12 thus increases as they must use different memory controllers 16 each configured to communicate with a specific type of memory 18. Hence the risk to manufacturers of data storage devices increases if one particular type of data storage device 12 falls into disfavor with consumers, or the specific type of memory 18 is no longer produced.

Memory controllers for data storage devices use ports, such as physical pins for example, to electrically couple signals with a host device and with at least one memory device. Memory controllers for solid state storage devices, such as USB memory sticks and SSD typically have multiple channels, where each channel is electrically connected to at least one memory device.

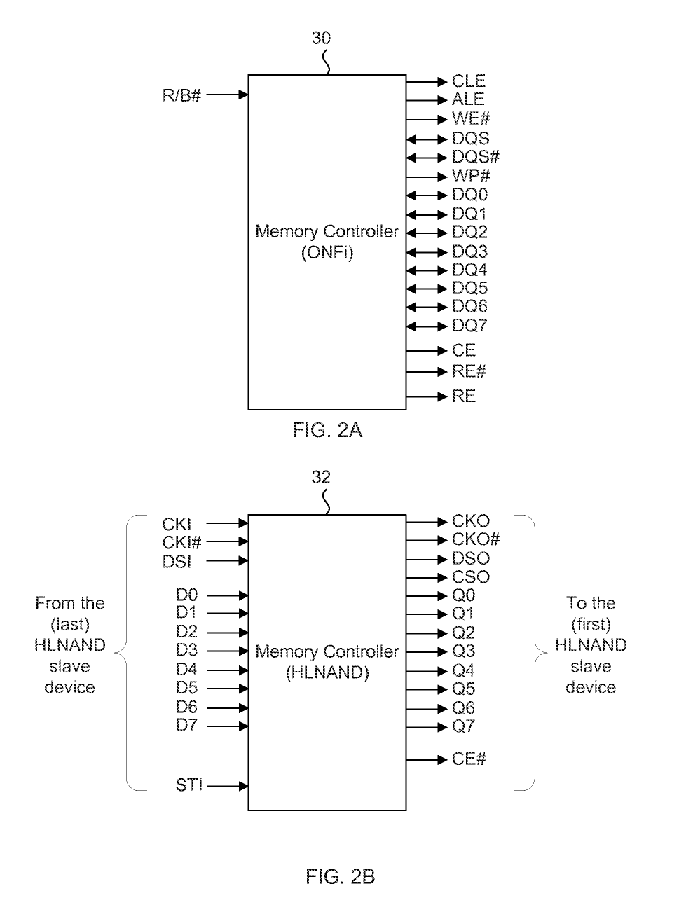

FIG. 2A shows the functional pinout of a memory controller 30 configured for the ONFi memory interface protocol, which is one example of a specific memory interface protocol. In the example of FIG. 2A, the ports for one channel are shown. Table 1 provides signal descriptions for the ports shown in FIG. 2A.

TABLE 1

| Pin Name | Type | Description |
|---|---|---|
| CE# | Output | Chip Enable: The Chip Enable signal selects the target NAND flash chip. |
| | | When Chip Enable is high and the target is in the ready state, the target goes |
| | | into a low-power standby state. When Chip Enable is low, the target is selected. |
| CLE | Output | Command Latch Enable: The Command Latch Enable signal controls the |
| | | target NAND flash chip to load a command from DQ[0:7] into its command |
| | | register. |
| ALE | Output | Address Latch Enable: The Address Latch Enable signal controls the target |
| | | NAND flash chip to load an address from DQ[0:7] into its address register. |
| WE# | Output | Write Enable |
| | | The Write Enable signal controls the latching of commands, addresses, and |
| | | input data. Data, commands, and addresses are latched on the rising edge of |
| | | WE#. |
| RE | Output | Read Enable True |
| | | The Read Enable (True) signal enables data output on DQ[0:7]. |
| RE# | Output | Read Enable Complement |
| | | The Read Enable Complement signal is the complementary signal to Read |
| | | Enable True. Specifically, Read Enable Complement has the opposite value of |
| | | Read Enable True when CE# is low, i.e., if RE is high then RE# is low; if RE is |
| | | low then RE# is high. |
| DQ[0:7] | I/O | Data Input/Output: DQ[0:7] The DQ port is an 8-bit wide bidirectional port for |
| | | transferring address, command, and data to and from the device. |
| DQS | I/O | DQ Data Strobe True: DQS is a data strobe signal providing synchronous |
| | | reference for data input. The data strobe signal that indicates the data valid |
| | | window. |
| DQS# | I/O | DQ Data Strobe Complement |
| | | The Data Strobe Complement signal is the complementary signal to Data |
| | | Strobe True, optionally used in the NV-DDR2 data interface. Specifically, Data |
| | | Strobe Complement has the opposite value of Data Strobe True when CE# is |
| | | low, i.e. if DQS is high then DQS# is low; if DQS is low then DQS# is high. |
| WP# | Output | Write Protect: Protects against inadvertent PROGRAM and ERASE |
| | | operations. All PROGRAM and ERASE operations are disabled when WP# is |
| | | LOW. |
| R/B# | Input | Ready/Busy: The Ready/Busy signal indicates the target status. When low, |
| | | the signal indicates that one or more LUN operations are in progress. This |
| | | signal is an open drain output and requires an external pull-up. |

In the presently shown example, 8 ports are required for the 8-bit wide data signals, and 9 ports are required for carrying control signals required for enabling operation of an ONFi flash memory device. Therefore a total of 17 ports are required for the channel to be connected to at least one ONFi flash memory device. If the memory controller 30 included 8 channels, then the memory controller 30 requires at least 8×17=136 ports. This excludes the ports required for interfacing with the host system.

FIG. 2B shows the functional pinout of a memory controller 32 configured for another type of memory device operating in another protocol, which is one example of a selected memory interface protocol. One example of a selected memory interface protocol is HLNAND™ memory interface protocol. Memory devices may operate in another type of memory interface protocol. In the example of FIG. 2B, the ports for one channel are shown. Table 2 provides signal descriptions for the ports shown in FIG. 2A.

TABLE 2

| Pin Name | Type | Description |
|---|---|---|
| CKI/CKI# | Input | Clock: CKI and CKI# are the clock inputs from the (last) HLNAND ™ device. CKI |
| | | and CKI# are differential signals. All incoming command, address, read-out data |
| | | from the (last) HLNAND device are referenced to the crossing edges of CKI and |
| | | CKI# in both directions. |
| CKO/ | Output | Clock: CKO and CKO# are differential clock outputs. All outgoing command, |
| CKO# | | address, and data are referenced to the crossing edges of CKO and CKO#. |
| CE# | Output | Chip Enable: When CE# is LOW, the device is enabled. Once device becomes |
| | | “BUSY”, CE# pin should be LOW until the device becomes “READY”. In addition, |
| | | CE# LOW activates and CE# HIGH deactivates the internal clock signals. |
| D[7:0] | Input | Data Input: D[7:0] receive read-out data from the (last) HLNAND device when |
| | | DSI is HIGH and referenced to the crossing edges of CKI and CKI# in both |
| | | directions. |
| Q[7:0] | Output | Data Output: Q[7:0] transmits command and/or address packet along with CSO, |
| | | and transmit write data along with DSO during write operation. |
| CSO | Output | Command Strobe Output: When CSO is HIGH, command, address and/or write |
| | | data through D[7:0] are latched on the crossing of CKI and CKI# by the device. |
| | | When CSO is LOW, the device ignores input signals from D[7:0]. CSO is used |
| | | with command and address packets only. |
| CSI | Input | Command Strobe Input: Echo signal of CSO. May not be used by the controller |
| | | in certain cases. |
| DSI | Input | Data Strobe Input: Echo signal of DSO. DSI is referenced to the crossing edges |
| | | of CKO and CKO# and delineates the valid read-out data on D[7:0] pins from the |
| | | Q[7:0] pins of the (last) HLNAND device. |
| DSO | Output | Data Strobe Output: After READ-group commands, DSO enables the Q[7:0] |
| | | buffer of the selected HLNAND device when HIGH. When DSO is LOW and CSO |
| | | is LOW, the Q[7:0] buffer of the selected HLNAND device holds the previous |
| | | states. After WRITE-group commands and DSO is HIGH, write data packets |
| | | through Q[7:0] are transmitted to the (first) HLNAND device and shall be latched |
| | | by the selected device on the crossing of CKI and CKI#. |
| STI | Input | Status Input: Status Input Pin. It indicates the status of the last |
| | | HLNAND memory device operation. When the device operation is |
| | | completed, STI pin indicates an asynchronous active high (or low) |
| | | short pulse. If multiple devices are daisy-chained, the short pulse |
| | | signal will be bypassed through the chain asynchronously or |
| | | synchronously. |

In the presently shown example, 8 ports are required for the Q0-Q7 data output, 8 ports are required for the D0-D7 data input, and 9 ports are required for carrying control signals required for enabling operation of an HLNAND flash memory device. Therefore a total of 26 ports are required for the channel to be connected to at least one HLNAND flash memory device. If the memory controller 32 included 8 channels, then the memory controller 32 requires at least 8×25=200 ports. This excludes the ports required for interfacing with the host system.

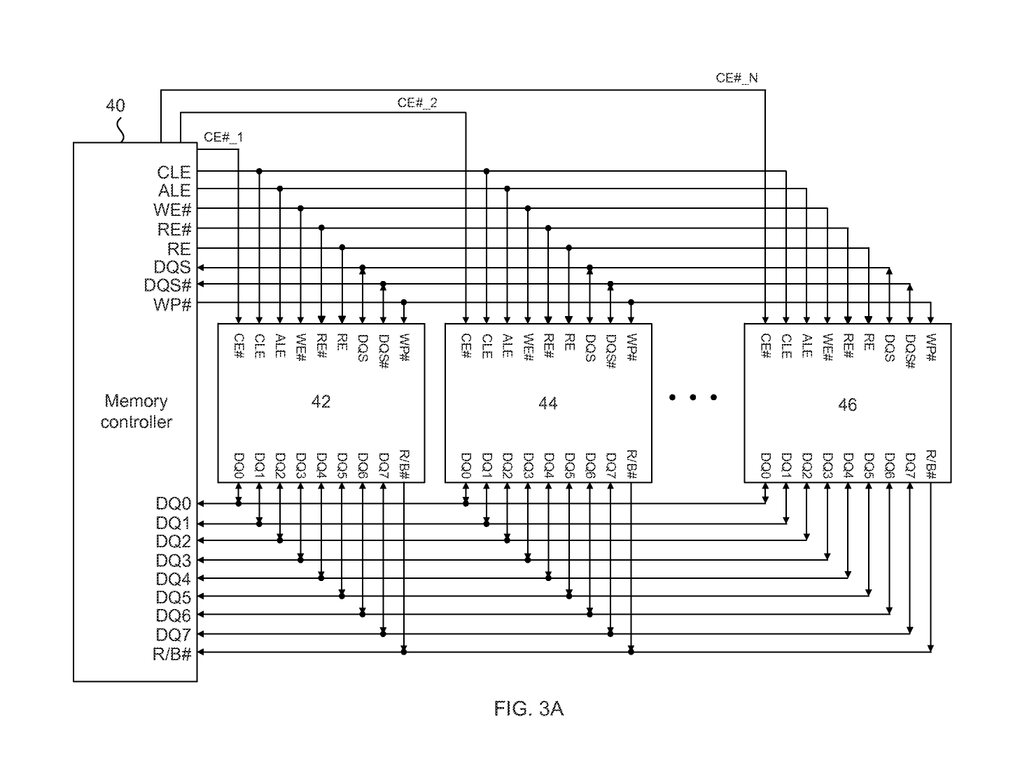

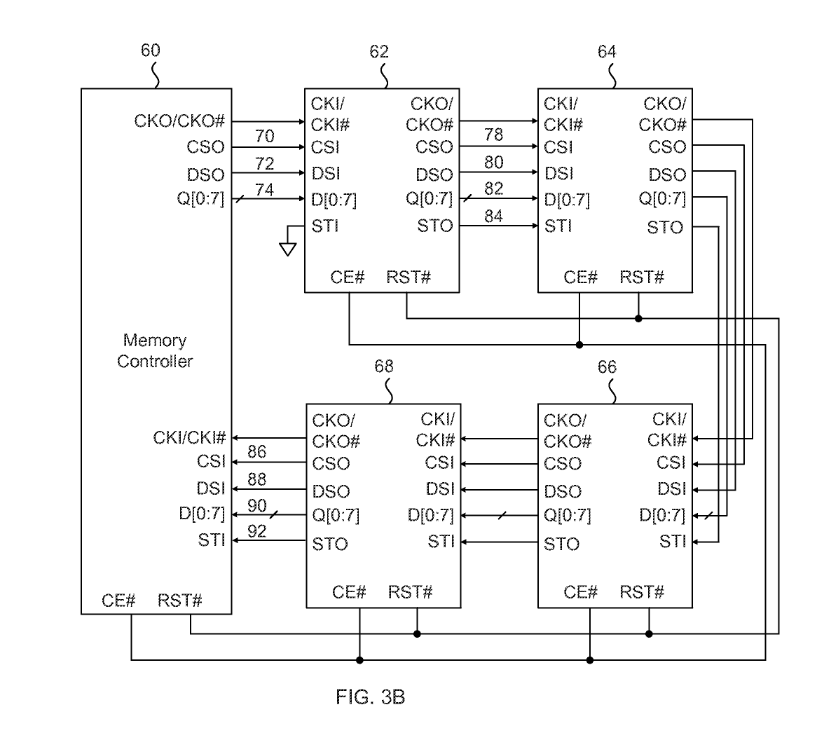

While certain signal names and functions of the ONFi and HLNAND memory interface protocols may appear similar to each other, the manner in which they are used and the manner in which the memory devices are interconnected with the memory controller are very different from each other. This difference is illustrated in FIGS. 3A and 3B.

FIG. 3A illustrates an example nonvolatile memory system using ONFi NAND flash devices. The memory system includes an ONFi configured memory controller 40 and several ONFi flash devices 42, 44 and 46. All input and output signals except chip select (CE#) signal in each flash memory device are connected to common bus or channel. Thus, the ONFi flash devices 42, 44 and 46 are connected in parallel with the memory controller 40, and is also referred to as a multi-drop configuration. Each ONFi NAND flash memory device can be selected by enabling CE# signal. For example, the first ONFi flash device 42 can be selected and accessed by asserting CE#_1 (CE#_1=Low). The rest of the ONFi flash devices are unselected by keeping CE#_2 and CE#_N High, such and they ignore any input like commands or addresses from the memory controller 40. Also the output signals of the unselected ONFi flash devices are set to a high impedance (i.e. Hi-Z) state.

Each of the ONFi flash devices 42, 44 and 46 use the same electrical signals for coordinating commands and data transfer between the ONFi flash device and a host controller device (not shown) through a channel control module. In the presently shown example, the ports for one channel control module are shown in FIG. 3A. Those signals include data lines and control signals, such as ALE (Address Latch Enable), CLE (Command Latch Enable), WE# (Write Enable), RE# (Read Enable), and others as previously shown in Table 1. This type of interface protocol is known in the art as “ONFi NAND interface”. Even though the “NAND interface protocol” has not, to date, been formally standardized by a standardization body, the manufacturers of NAND flash devices all follow the similar protocol for supporting the basic subset of NAND flash functionality. This is done so that customers using NAND flash memory devices within their electronic products could use NAND flash memory devices from any manufacturer without having to tailor their hardware or software for operating with the devices of a specific vendor. It is noted that some NAND flash memory vendors can provide extra functionality beyond this basic subset of functionality, while ensuring that the basic functionality is provided in order to provide compatibility with the protocol used by the other vendors.

FIG. 3B illustrates an example of a non-volatile memory system using HLNAND flash memory devices. The memory system includes an HLNAND™ configured memory controller 60 and several HLNAND compatible flash devices 62, 64, 66 and 68. Referring to FIG. 3B, the HLNAND memory devices 62, 64, 66 and 68 uses a highly multiplexed unidirectional point-to-point bus architecture to transfer information such as commands, addresses and data. Each interconnection of these commands, addresses and data between memory devices is referred to as a “Link”. In one example, one single link consists of seven signals, CSI (=Command Strobe Input), CSO (=Command Strobe Output), DSI (=Data Strobe Input), DSO (=Data Strobe Output), D[0:7] (=Data Input), STI (=Status Input) and Q[0:7] (=Data Output), along with two differential clock input signals, CKI/CKI#, clock output signals, CKO/CKO# and common signals CE# (Chip Enable) and RST# (Reset).

Following is a brief discussion of the way some of these control signals are used in the memory system of FIG. 3B. CKI/CKI# are input clocks. A Command/Address Packet on the D[0:7] ports delineated by CSI is latched on the rising edges of CKI or the falling edges of CKI#. A Write Data Packet on D[0:7] delineated by DSI is latched on the rising edges of CKI or the falling edges of CKI#. A Read Data Packet on Q[0:7] delineated by DSO is referenced at the rising edges of CKO or the falling edges of CKO#. CKO/CKO# are output clocks which are delayed version of CKI/CKI#.

CSO, DSO and Q[0:7] signals are referenced to the rising edges of CKO or to the falling edges of CKO#. When the Command Strobe Input (=CSI) is HIGH, Command/Address Packets through D[0:7] are latched on the rising edges of CKI or falling edges of CKI#. Command Strobe Output (=CSO) is an echo signal of CSI. It bypasses (=or echoes) CSI transitions with one clock cycle latency (=tIOL) referenced to the rising edges of CKO or to the falling edges of CKO#. One clock cycle latency is one of exemplary embodiment in this disclosure, however it could be any number of clock cycles depending on the design variations.

When Data Strobe Input (=DSI) is HIGH while the HLNAND compatible memory device is in ‘Read-Mode’, it enables the read data output path and Q[0:7] buffer. If DSI is LOW, the Q[0:7] buffer holds the previous data accessed. If DSI is HIGH while the memory device is in ‘Write-Mode’, it enables the D[0:7] buffers and receives a Write Data Packet on the rising edges of CKI or falling edges of CKI#.

Data Strobe Output (=DSO) is an echo signal of DSI. It bypasses or echoes DSI transitions with one clock cycle latency (=tIOL) referenced to the rising edges of CKO or to the falling edges of CKO#. One clock cycle latency is one of exemplary embodiment in this disclosure, however it could be any number of clock cycles depending on the design variations.

At any time, the memory controller 60 may issue a request for the status of a specific memory device, in particular to determine if the selected memory device has completed a particular operation. In response, the selected memory device receiving the status request will pulse its STO output to indicate that a pending operation has been completed. The memory controller 60 will receive the pulse at its STI input and can then issue further commands to same memory device. The memory controller 60 can be set to wait a predetermined amount of time for an STO pulse. If no STO pulse is received after the predetermine amount of time has elapsed, then the memory controller 60 can determine that the selected memory device is still busy. In this situation, the memory controller 60 can then execute further operations for other memory devices.

The Data Input signal D[0:7] carries command, address and/or input data information, while the Data Output signal Q[0:7] (n=0, 1, 2, 3, 4, 5, 6 or 7) carries output data during a read operation or bypasses command, address or input data received on D[0:7].

The memory controller 60 drives differential clocks from its ports CKO/CKO#, and all of the HLNAND compatible memory devices 62, 64, 66 and 68 receive the differential clock buses through their own clock ports, CKI/CKI#, from the previous CKO/CKO# ports in a series flow-through manner. The memory controller 60 drives four different buses 70, 72, 74 and 76 through its ports, CSO, DSO and Q[0:7], respectively. The first memory device 62 receives the buses, 70, 72 and 74, through its ports, CSI, DSI and D[0:7] respectively. It is noted that the first memory device has its STI port grounded as there are no STO pulses from a previous memory device to receive. The first memory device 62 re-drives four corresponding buses, 78, 80, 82 and 84 through its output ports, CSO, DSO, Q[0:7] and STO, respectively, with one clock cycle of latency (=tIOL). This pattern of receiving signals and re-driving them to successive memory devices continues until the last memory device 68 re-drives the final buses, 86, 88, 90 and 92 back to the memory controller 60 through the memory controller's input ports, CSI, DSI, D[0:7], and STI, respectively. In the present example, it is not necessary to re-drive the signal from the CSO port of memory device 68, therefore the CSI input port of memory controller 60 may be omitted, and final bus 88 is not required.

It should be clear to any person skilled in the art that the ONFi and HLNAND memory interface protocols differ sufficiently from each other, and any memory controller configured for the ONFi memory interface protocol will not work with HLNAND memory devices, and vice versa. The previously discussed ONFi and HLNAND memory systems are merely examples of two different types of memory interface protocols that are not compatible with each other. Any of the previously mentioned memory device types are highly unlikely to be compatible with each other, as each type requires a specific memory interface protocol that would not work with a different memory device type.

In view of the different types of available memory devices, manufacturers may design different data storage device devices based on different types of memory devices. For example, traditional NAND flash memory device based data storage devices are commonly available due to the availability and low cost of traditional NAND flash memory devices. By example, these can be ONFi type flash memory devices. Unfortunately, the multi-drop configuration of the ONFi type flash memory system as shown in FIG. 3A will have a finite number of memory devices which can be connected in parallel to one channel of the memory controller 40 without degrading the overall speed and performance of the system. This is due to the cumulative loading effects of each memory device connected to the bus. Therefore, while the cost of such a data storage device may be low, the maximum storage density will also be relatively low.

On the other hand, the HLNAND type of memory device does not suffer from the limitations of multi-drop configured memory systems. In the HLNAND memory system, such as the one shown in FIG. 3B by example, any number of memory devices can be connected in series with each other with one channel of the memory controller 60. Therefore the total storage density of a data storage device using HLNAND type of memory devices can be very large.

The problem faced by manufacturers is the need to purchase different memory controllers configured for a specific type of memory device, or a specific memory interface protocol, for producing different types of data storage devices. To mitigate cost risk, a memory controller configured to operate with two or more memory interface protocols is possible, provided separate ports are available for connection with the selected type of memory device. Unfortunately, providing separate sets of ports becomes impractical due to the number of ports that would be required on the memory controller package. Take for example the ONFi and HLNAND memory controller examples, which were discussed earlier. If an 8 channel ONFi interface requires a total of 136 ports only for ONFi NAND signals, and an 8 channel HLNAND memory controller interface requires a total of 208 ports, then a memory controller configured to operate in either interface protocol would require 344 ports. It should be appreciated by persons skilled in the art that a memory controller package size is dominated by the number of ports. Therefore, a package having 344 ports would likely be significantly larger in area than a package having 136 ports or 208 ports.

According to an embodiment of the disclosure, a memory controller configurable to operate in at least one of three different modes is provided. The ports of a channel are mapped to three different functional assignments, where each functional assignment corresponds to the signals specific to a memory interface protocol. Each port includes a pad for electrical connection to a signal conductor line to a memory device, and buffer circuitry for each of the three functional assignments. Different buffer circuitry of each port is selectively enabled based on the selected mode to be used. In one example embodiment, one mode of operation corresponds to a first memory interface protocol, such as the ONFi protocol, a second mode of operation corresponds to the outbound or output signals of the HLNAND protocol, and a third mode of operation corresponds to the inbound or input signals of the HLNAND protocol.

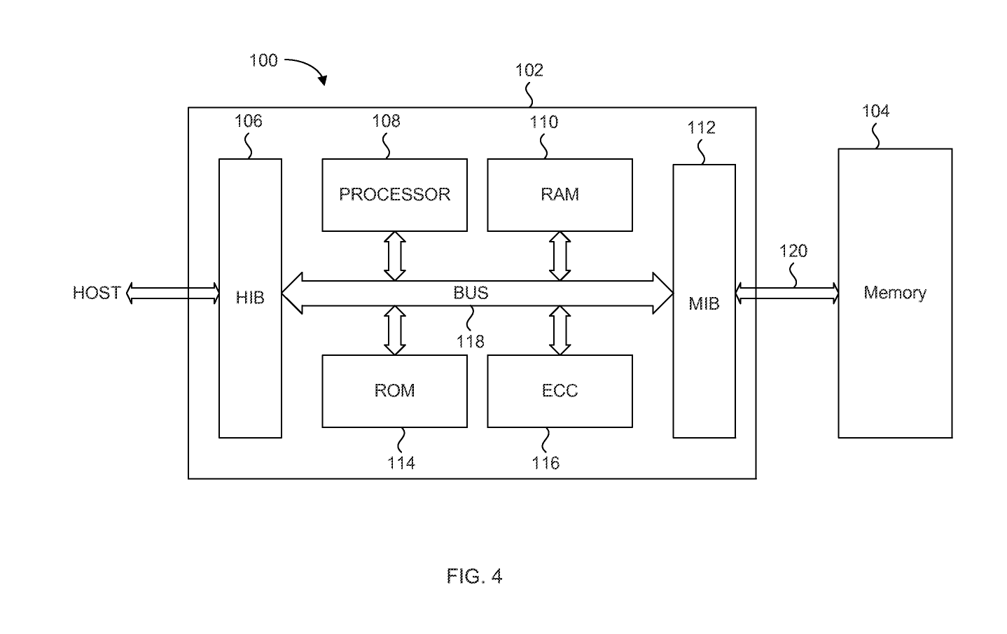

A block diagram of a solid state storage device using a multi mode pinout memory controller according to an embodiment of the present disclosure is shown in FIG. 4. The solid state storage device 100 includes a multi function pinout memory controller 102 and memory 104. In certain embodiments, the memory 104 includes non-volatile memory such as ONFi flash memory devices or HLNAND flash memory devices. In the present embodiment, any type of memory devices can be used as memory 104. In the present context, memory 104 includes memory devices.

The controller 102 controls overall operations of the solid state storage device 100, and controls exchange of data between the host and the memory 104. For example, the controller 102 controls the memory 104 to write data or to read data, in response to a request from the host (not shown). Also, the controller 102 controls internal operations, such as for example, performance control, merging and wear leveling, which are needed for the characteristics of nonvolatile memory, or for efficient management of the memory 104. The controller 102 drives firmware and/or software for controlling operations of the memory 104, which is referred to as a flash translation layer (FTL) (not shown). The controller 102 may control the memory 104 to control operation of a number of memories from among the multiple nonvolatile memories included in the memory device 104, based on a request from the host. The memory 104 provides storage medium for storing data. If memory 104 is at least a non-volatile memory device, the data is stored in a nonvolatile manner. For example, the nonvolatile memory device may store an operating system (OS), various programs, and various multimedia data.

In its primary mode of operation, the multi function pinout memory controller 102 controls exchange of data between the host and the memory 104. The multi function pinout memory controller 102 includes a host interface block (HIB) 106, a central processor unit 108, a random access memory (RAM) 110, a memory interface block (MIB) 112, a read only memory (ROM) 114, and an error correction code (ECC) engine 116 which are interconnected through a bus 118. The controller 102 may operate the FTL embodied as software or firmware. The RAM 110 is shown integrated within the controller 102, but it can be located outside of the controller 102 in alternate embodiments.

The host interface block 106 receives data, address information, external commands, and other signals from the host via host interface ports. These are generally referred to as information. The address information, commands and any other non-data related signals can be simply referred to as control information. Also, the host interface block 106 sends data, and status information to the host via the same or different host interface ports. These interface ports can include pins or other physical connectors. The received external commands from the host are used to control the memory controller 102. Data and other information provided by the host to the solid state storage device 100 are input into functional blocks of the solid state storage device 100, for example the buffer RAM 110, through the host interface block 106 as an inlet for data. Also, data and other information provided from the solid state storage device 100 to the host are provided through the host interface block 106 as an outlet for data.

The central processor 108 reads a program code from the ROM 114 or the memory 104, and controls all functional blocks included in the controller 102 according to the program code that is read. The program code specifies operations of the central processor 108. The central processor 108 controls access to the memory 104 on a basis of the program code read. In one mode of operation, the program code stored in the memory 104 is read from the memory 104 and written to the RAM 110 at a time when the solid state storage device 100 is booted up.

The RAM 110 may be used as an operating memory of the processor 108, and may be embodied as dynamic RAM (DRAM), static RAM (SRAM), or the like. Also, the RAM 110 may act as buffer memory for temporarily storing data received from the host. The processor 108 performs overall control operations to write data to, or read data from, the memory 104. Also, the processor 108 may control or otherwise perform operations of the FTL based on requests from the host.

The ECC block 116 generates an ECC (Error Correction Code) pertaining to data to be written to the memory 104. Data are stored together with the ECC pertaining thereto. Furthermore the ECC block 116 detects and corrects bit errors in data read from the memory 104 on a basis of the ECC associated with the read data.

The ROM 114 stores code data for interfacing with the host. In the ROM 114, firmware required for controlling the memory 104 is stored. Incidentally, only minimum firmware required for booting may be stored in the ROM 114 and the other firmware may be stored in the memory 104. Because the ROM is fixed read only memory, storing other firmware in the memory 102 facilitates updating of the firmware. The central processor 108, RAM 110, ROM 114, ECC engine 116 and any other circuits required for processing information received from the host or the MIB 112 can be referred to as core circuits.

The memory interface block 112 reads a sequence code from the ROM 114 or the memory 104. The sequence code specifies various operations performed by the memory interface block 112. The memory interface block 112 performs the various operations on a basis of the sequence code read. The sequence code is composed of a plurality of code sets. The code set comprises a plurality of codes. Each of the code sets specifies the operations corresponding thereto. In the operations performed on a basis of the sequence code, between the memory interface block 112 and the memory 104, data, address information, status information, internal commands and so on are transferred through an internal memory bus 120. The internal memory bus 120 includes signal conductor lines for electrically connecting ports of the controller 102 to corresponding ports of the memory 104. The internal memory bus 120 can carry signals corresponding to multiple channels. The internal command is for the controller 102 to control the memory 104, and the memory device 104 works according to the internal command. Incidentally, before the operations are performed, the sequence code stored in the memory 104 is read from the memory 104 and is written to the RAM 110.

The FTL includes a mapping table (not shown) for performing data mapping operations. In general, the mapping table is stored in the RAM 110. In the mapping table, multiple logical page numbers (LPNs) are recorded to be respectively mapped to the memory 104. In the example where memory 104 is implemented as one or more NAND flash memory devices, data is written or read in units of a page. The LPNs may therefore be used as mapping units.

Also, the FTL may control the memory 104 based on whether a request from the host is a write command or a read command, and may manage the mapping table to be updated whenever the write command or the read command provided by the host is performed on the memory 104. For example, when a request from the host is a write command, the FTL controls data to be written to one of the memory devices of memory 104 corresponding to an LPN, and writes the LPN and the corresponding memory device in the mapping table. When a request from the host is a read command, the FTL controls data to be read from one of the nonvolatile memories corresponding to an LPN, based on the mapping table.

As mentioned above, the memory 104 may include multiple nonvolatile memories, each of which may be implemented as a NAND flash memory device that executes operations with a specific memory interface protocol. According to the present embodiments, different types of memory devices having different memory interface protocols can be used with the same multi function memory controller 102. In the present embodiment, the memory interface block 112 includes one set of ports for each channel, where at least one port is dynamically configurable to function in one of three modes, where two of the three modes corresponds to one memory interface protocol and one of the three modes corresponds to a different memory interface protocol. Therefore two different types of memory 104 can be connected to a channel of the memory interface block 112 without the need for any additional ports, because both types of memory 104 can be connected to the same ports of the channel via the signal lines of bus 120.

According to a present embodiment, a first mode functions to receive and provide unidirectional and bidirectional signals for a first memory interface protocol, a second mode functions to provide only outbound signals for a second memory interface protocol, a third mode functions to receive only inbound signals for the second memory interface protocol. By example, the first mode corresponds to the ONFi memory interface protocol, or any similar multi-drop bus architecture memory interface protocol, while the second mode corresponds to the HLNAND memory interface protocol, or any similar point to point serial connected memory interface protocol.

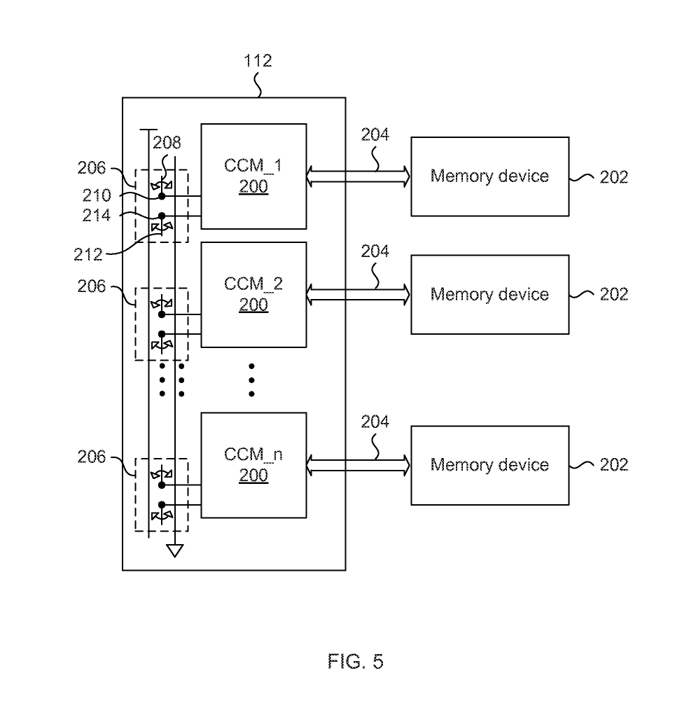

The ports can be configured to function in one of the three modes by connecting each of two dedicated or existing ports to either the positive or ground power supplies (VDD or VSS). Therefore up to four different modes can be selected with the VDD and VSS biasing combinations for each port. While such a technique is effective for selecting between one of three modes of operation, the memory interface block 112 can be configurable to operate in any number of modes. In FIG. 5, mode selection is achieved by biasing the mode select ports to either VDD or VSS. Alternately, a register can be electrically programmed by blowing fuses or antifuses, or laser programmed, to provide a multi-bit code to select one of n modes of operation. In all these embodiments, the required buffer circuitry for each mode of operation is selectively couplable to a respective port of memory interface block 112. The native memory controller signals received from the bus 118 are converted by the selected buffer circuitry into a format compatible with the selected memory interface protocol. Similarly, signals received from the bus 120 are converted by the selected buffer circuitry into the native memory controller signals.

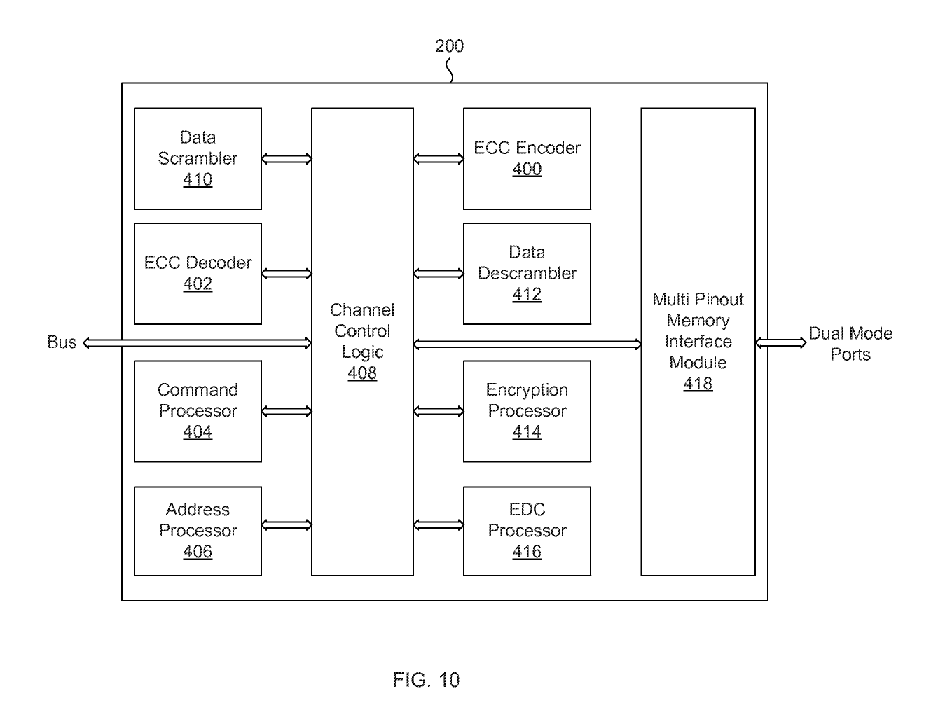

Prior to discussing the details of the port buffer circuitry, the organization of the memory interface block 112 is first described with reference to FIGS. 5 and 10.

FIG. 5 shows a block diagram of a memory interface block 112 of the multi function memory controller 102 shown in FIG. 4, where the memory interface block 112 is connected to at least one memory device. The memory interface block 112 includes up to n channel control modules (CCM) 200, where n can be any integer value greater than zero. Each channel control module 200 is associated with a channel of a first memory interface protocol, and one of two sub-channels of a second memory interface protocol. Accordingly, each pairing of channel control modules 200 are combined together to form a channel of the second memory interface protocol. With reference to the previously discussed example, one sub-channel includes the outbound signals while the second sub-channel includes the inbound signals, or vice versa.

Each channel control module 200 is connected to at least one memory device 202 via channel buses 204. It is noted that the collection of channel busses 204 forms bus 120 shown in FIG. 4. Similarly, all the memory devices 202 are included within memory 104 shown in FIG. 4. In the embodiment where a pair of channel control modules 200 form a channel for the second memory interface protocol, the memory devices 202 connected to the pair of channel control modules 200 are further connected to each other in the point-to-point serial configuration as shown in FIG. 3B by example.

The memory interface block 112 further includes a mode selector 206 corresponding to each channel control module. Each mode selector 206 includes a first selector 208 for biasing a first mode select port 210 to either VDD or VSS, and a second selector 212 for biasing a second mode select port 214 to either VDD or VSS. The VDD and VSS voltages are shown as rails extending in the vertical direction of FIG. 5 within memory interface block 112. Accordingly, different channel control modules 200 can be set to operate in different modes. The ports 210 and 214 can be biased to VDD or VSS through any suitable means.

According to the present embodiment, each channel control module 200 includes one set of ports, where at least one of the ports includes buffer circuitry that is configurable to function in at least one of three different modes, in response to the first and second mode selection signals. In an example of a first mode, if the memory devices 202 are ONFi type flash memory devices, then the interconnection configuration of the memory devices 202 and its channel control module would appear as shown in FIG. 3A. In an example of a second mode, if the memory devices 202 are HLNAND type flash memory devices, then the interconnection configuration of the memory devices 202 and its channel control module would appear as shown in the top half of FIG. 3B which includes memory devices 62 and 64, and outbound signals CKO/CKO#, CSO, DSO, and Q[0:7]. In an example of a third mode, if the memory devices 202 are HLNAND type flash memory devices, then the interconnection configuration of the memory devices 202 and its channel control module would appear as shown in the bottom half of FIG. 3B which includes memory devices 66 and 68, and inbound signals CKI/CKI#, CSI, DSI, D[0:7] and STI. According to the present embodiments, both the ONFi type flash memory devices and the HLNAND type flash memory devices can be connected to the channel control modules 200.

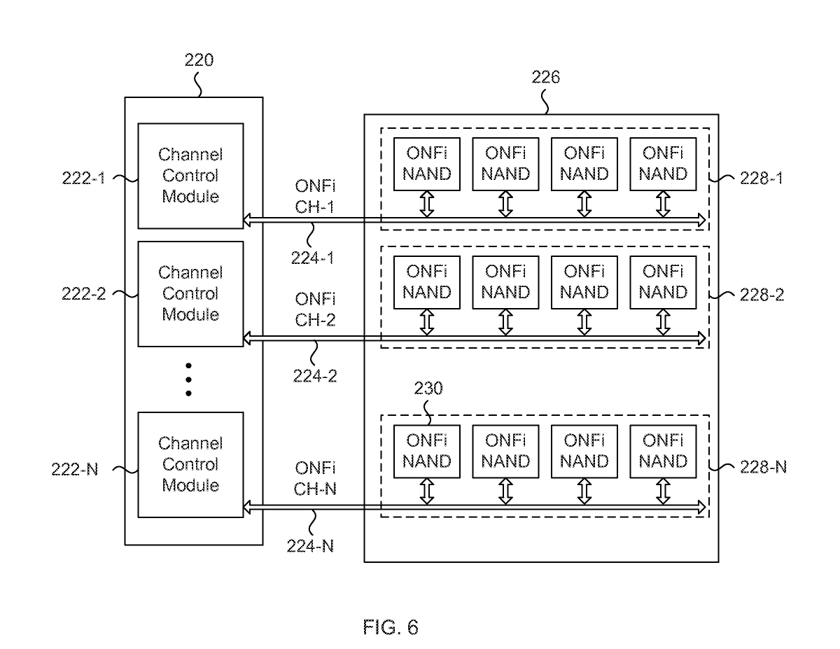

FIG. 6 is a block diagram of a multi-drop bus architecture memory system having a multi function memory controller, according to one embodiment. More specifically, FIG. 6 shows an example configuration of the solid state storage device 100 of FIG. 4, configured in a multi-drop architecture. The memory interface block 220 of the multi function memory controller includes a plurality of channel control modules 222-1 to 222-N each for controlling a respective channel 224-1 to 224-N, also referred to as ONFi CH-1 to ONFi CH-N. It is noted that “N” is an integer number denoting the last unit of the element the base number refers to. The channels are provided to a non-volatile memory 226. In electrical communication with each channel is a memory device 228-1, 228-2 and 228-N, where each memory device can be a single packaged memory device. Each of the memory devices includes a number of ONFi nonvolatile NAND flash memory chips 230, of which only one is annotated in FIG. 6. Each ONFi NAND flash memory chip 230 is in bi-directional communication with its associated channel for receiving information from a channel control module, or for providing information to a channel control module. The memory chips 230 of a memory device are connected in parallel with a channel.

Each of the channel control modules 222-1 to 222-N of the memory interface block 220 is dedicated to a respective channel ONFi CH-1 to ONFi CH-N of the nonvolatile memory 226, for the purpose of controlling the nonvolatile memory 226, and in particular, the individual memory devices 228-1 to 228-N. For example, the flash translation layer (FTL) which is generally firmware and/or software, controls the operations of the channel control modules 222-1 to 222-N corresponding to the channels ONFi CH-1 to ONFi CH-N in order to control the nonvolatile memory 226 to activate or deactivate various ONFi NAND flash memory chips 230 connected to channels ONFi CH-1 to ONFi CH-N, based on requests from a host. Activation of a memory chip can include initiating various types of memory operations in the selected memory chip.

In order to increase storage capacity and to improve the signal integrity on large numbers of non-volatile flash memory devices implemented in the solid state storage systems such as SATA or PCIe based solid state drives (SSDs) for HDD replacement, an alternate type of flash memory can be used. One example alternate type of flash memory is the previously described HLNAND flash memory. HLNAND flash memory is an advanced and high performance synchronous non-volatile flash memory device using point-to-point serial connection technology, typically arranged in a ring topology with a memory controller, as shown in FIG. 3B for example.

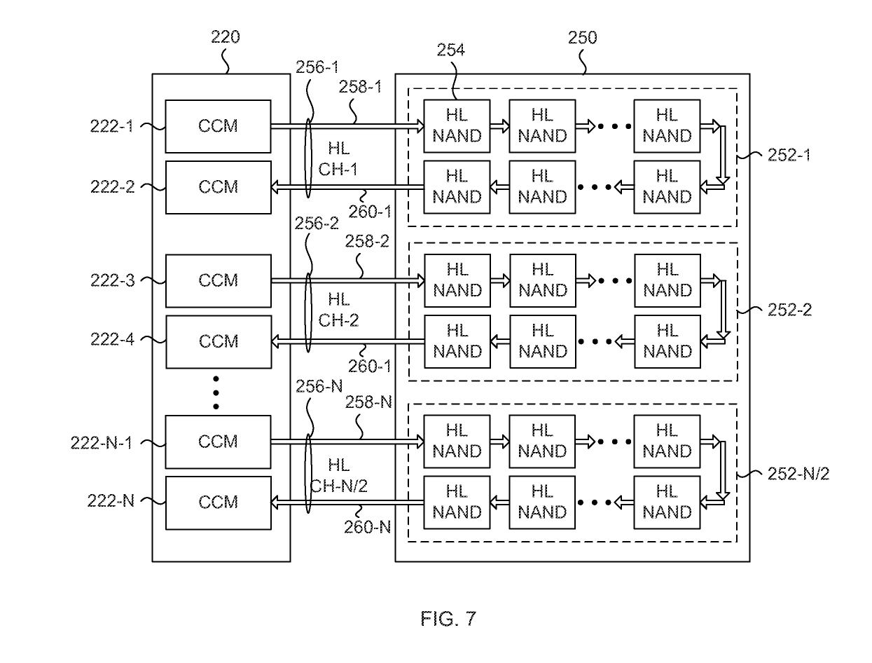

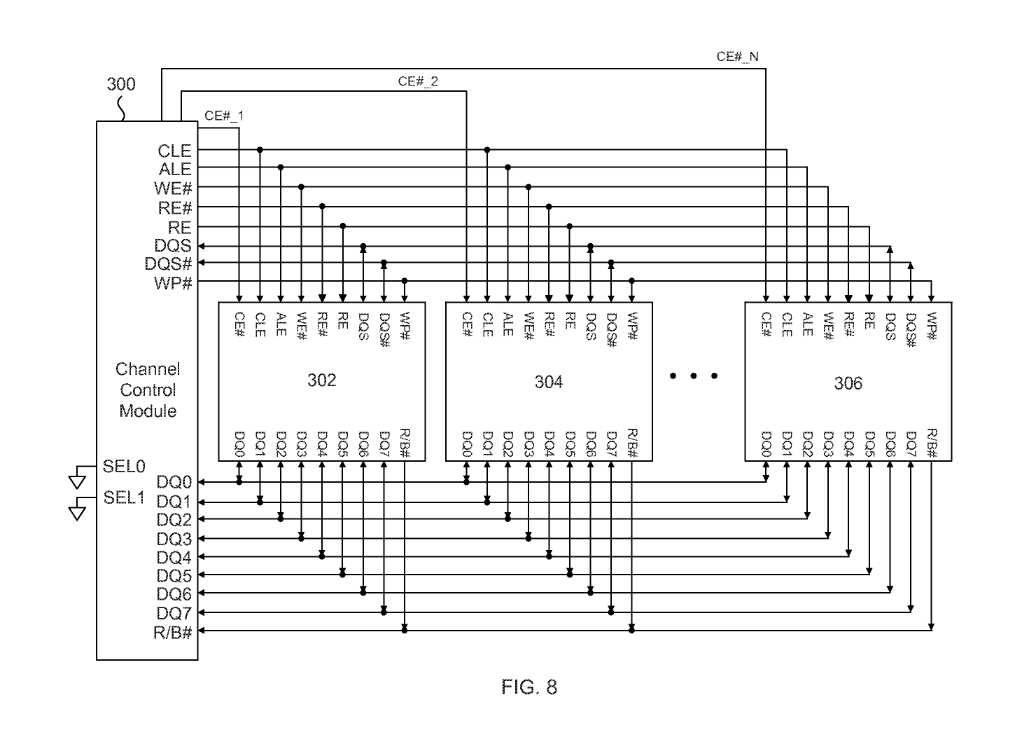

FIG. 7 is a block diagram of a serial point-to-point architecture memory system having the same multi function memory controller as the memory system of FIG. 6, according to the present embodiment. More specifically, FIG. 7 shows an example configuration of the solid state storage device 100 of FIG. 4, configured in a serial point-to-point architecture using HLNAND flash memory. The memory interface block 220 has the same channel control modules 222-1 to 222-N. One difference in the embodiment of FIG. 7 over the embodiment of FIG. 6 is that non-volatile memory 250 consists of HLNAND flash memory devices. As shown in FIG. 7, non-volatile memory 250 includes HLNAND flash memory devices 252-1 to 252-N/2, each of which can include a packaged device consisting of a plurality of HLNAND memory chips 254, of which only one is annotated. In the present embodiment, there are half as many HLNAND flash memory devices 252 as there are channel control modules 222. All the HLNAND memory chips 254 of a memory device, such as memory device 252-1 for example, are serially connected to each other via unidirectional, point-to-point connections. These point-to-point connections are formed in one example by having output pins of a device connected to input pins of the next device, and can take the form of a unidirectional bus. Accordingly, this serial interconnection can be also be referred to as a daisy-chain cascade connection, or a ring topology configuration with a host, such as channel control module 222-1.

Accordingly, another difference over the embodiment of FIG. 6 is that each pairing of channel control modules 222-1 to 222-N are connected to respective HLNAND channels 256-1 to 256-N, also referred to as HL CH-1 to HL CH-N/2. Each of the HLNAND channels includes an inbound sub-channel 258-1 and an outbound sub-channel 260-1. The inbound sub-channel 258-1 is the set of connections for providing data and control information to the first HLNAND memory chip 254 of the serially connected memory chips of memory device 252-1, from output terminals of the channel control module 222-1. The outbound sub-channel 260-1 is the set of connections for providing data and control information from the last HLNAND memory chip 254 of the serially connected memory chips of memory device 252-1, to input terminals of the channel control module 222-2. Accordingly, with a total of N channel control modules where each pair of channel control modules 222 are dedicated to one channel of an HLAND flash memory device 252, the presently shown configuration accommodates up to N/2 HLAND flash memory devices 252 and N/2 HLNAND channels 256.

Therefore, the channel control modules 222-1 to 222-N in this system need only to interface with either the first HLNAND memory chip or the last HLNAND memory chip of the memory device. As a result, there are no clock skew and data skew problems which are caused by physical distance differences among chips in a system using the multi-drop connection. Furthermore, due to the use of point-to-point connections between memory chips and the corresponding channel control module, no bus termination that is typically used in multi-drop bus architectures is required. As a result, lower power consumption compared to a flash memory system using a multi-drop bus architecture is realized.

As there is a pair of channel control modules associated with the memory chips of each memory device, the FTL may control the operations of each pair of the channel control modules 222-1 to 222-N in order to control the non-volatile memory 250 to activate or deactivate various HLNAND flash memory chips 254 corresponding to the channels HL CH-1 to HL CH-N/2, based on requests from a host device, such as host 14 of FIG. 1. Activation of a memory chip can include initiating various types of memory operations in the selected memory chip.

The previously shown embodiments of FIGS. 6 and 7 illustrate memory systems using the same multi function memory controller according to the present disclosure. The ONFi and HLNAND memory types used for non-volatile memory 226 and 250 are merely examples of two different types of memories the multi function memory controller of the present disclosure can be used with. Different embodiments of the multi function memory controller can be configured to interface with combinations of presently known memories and future memories which have differing input/output interfaces.

FIG. 8 is a schematic showing interconnection details of an example multi-drop bus architecture memory system of FIG. 6, according to an embodiment of the present disclosure. FIG. 8 shows interconnections between one channel control module of the multi function memory controller 220 of FIG. 6, such as channel control module 222-1, and a memory device such as memory device 228-1 of FIG. 6. In FIG. 8, the multi-pinout channel control module 300 is connected to a plurality of memory devices 302 and 304 to 306. Each of the memory devices 302 and 304 to 306 can be formed as semiconductor chips, all of which are embedded in a single package of a memory device. Alternately, each memory device can be a single semiconductor chip embedded in its own package. The signals provided by and received by channel control module 300 are the same as those shown for memory controller 40 of FIG. 3A. Similarly, the signals provided by and received by each of the memory devices 302 and 304 to 306 are the same as those shown for memory devices 42 and 44 to 46. In the present example, the memory devices 302 and 304 to 306 are ONFi memory devices.

In FIG. 8, channel control module 300 includes two additional mode selection ports labeled SEL0 and SEL1, each of which can be selectively biased to VDD or VSS to set the operating mode thereof. In the presently shown example, SEL0 and SEL1 are tied to VSS to set a first mode of operation in which the channel control module ports are configured to operate with the ONFi memory interface protocol. The biasing of SEL0 and SEL1 can be provided by the first and second mode selectors 206 and 208 of FIG. 5 by example. Accordingly, channel control module 300 is now compatible with the memory devices 302 and 304 to 306. In the present example, SEL0 and SEL1 are biased to VSS for setting the ONFi memory interface protocol mode of operation, however any predetermined biasing combination for SEL0 and SEL1 can be used.

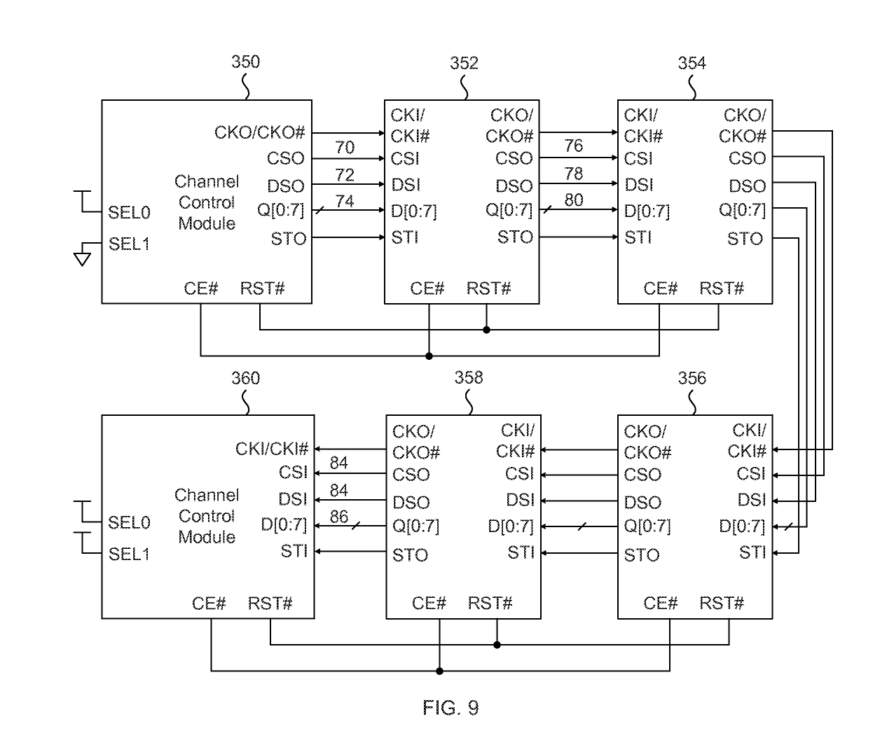

FIG. 9 is a schematic showing interconnection details of an example serial point-to-point architecture memory system of FIG. 7, according to an embodiment of the present disclosure. FIG. 9 shows interconnections between a pair of channel control modules of the multi function memory controller 220 of FIG. 7, such as channel control modules 222-1 and 222-2, and a memory device such as memory device 252-1 of FIG. 7. In FIG. 8, a first multi function channel control module 350 is connected to a first memory device 352, which is in turn connected to a second memory device 354. The second memory device 354, a third memory device 356 and a fourth memory device 358 are serially connected with each other, and the output of the fourth memory device 358 is connected to a second multi function channel control module 360. Each of the memory devices 352, 354, 356 and 358 can be formed as semiconductor chips, all of which are embedded in a single package of a memory device. Alternately, each memory device can be a single semiconductor chip embedded in its own package. Alternately, each memory device can be a multi-chip package containing at least two semiconductor chips which are serially connected with each other with the same configuration as shown between two of the memory devices of FIG. 9.

The CKO/CKO#, CSO, DSO, Q[0:7] and STO signals provided by first multi function channel control module 350 are the same as those provided by memory controller 60 of FIG. 3B. The CKI/CKI#, CSI, DSI, D[0:7] and STI signals received by second multi pinout channel control module 360 are the same as those received by memory controller 60 of FIG. 3B. Accordingly, the signals received and provided by each of the memory devices 352, 354, 356 and 358 are the same as those shown for memory devices 62, 64, 66 and 68. In the present example, the memory devices 352, 354, 356 and 358 are HLNAND memory devices.

In FIG. 9, the first channel control module 350 has its SEL0 and SEL1 ports tied to VDD and VSS respectively, to set a second mode of operation in which the channel control module ports are configured to operate with the HLNAND outbound memory interface protocol. The second channel control module 360 has its SEL0 and SEL1 ports tied to VDD and VDD respectively, to set a third mode of operation in which the channel control module ports are configured to operate with the HLNAND inbound memory interface protocol. In this embodiment, the SEL0 port can be used to select either the ONFi or HLNAND operating modes. The SEL1 port is ignored when the SEL0 port is set to select the ONFi operating mode. On the other hand, the SEL1 port is used to select a sub-mode of the HLNAND operating mode when the SEL0 port is set to select the HLNAND operating mode. Accordingly, channel control modules 350 and 360 are now compatible with the memory devices 352, 354, 356 and 358. Different voltage biasing combinations for SEL0 and SEL1 other than those shown in the example of FIG. 9 can be used for setting the sub-modes of the HLNAND memory interface protocol mode of operation.

FIG. 10 is a block diagram of one of the channel control modules 200 shown in FIG. 5. In this particular embodiment, the channel control module 200 is configurable to operate with one of two memory interface protocols. For the purposes of example illustration, the two memory interface protocols being used are the ONFi and HLNAND memory interface protocols.

In the presently shown embodiment, the channel control module 200 includes an ECC encoder 400, an ECC decoder 402, a command processor 404, an address processor 406, channel control logic 408, a data scrambler 410, a data descrambler 412, an encryption processor 414, an EDC processor 416, and a multi memory interface module 418. The multi memory interface module 418 includes a set of ports for electrical coupling to a memory device (not shown). The function of some of the above mentioned components is described with further reference to the block diagram of FIG. 4.

Generally, the data that is programmed into the memory device through the channel control module 200 has an error detection or error correction code appended to it and stored with the main data in the memory cell array of the memory device.

The channel control module 200 uses the ECC encoder 400 for this function. When such data is read from the memory device to the RAM 110 of FIG. 4, the ECC decoder 402 re-generates the ECC code from the data and compares it to the ECC code that was appended to the data when programmed into the memory device. If the data is identical to the data that was written, the ECC circuits indicate that there is no data error present. If some difference in the read data is detected, and the difference is small enough to be within the capability of the ECC to correct, the read data (typically contained in the RAM 110) is “corrected” or modified to restore it to the original value by the ECC correction engine 116, as controlled by the processor 108. If the data errors exceed the ECC correction capability, an “uncorrectable” read error occurs. Typically, an uncorrectable read error would result in an error status being returned to the host interface when read.

When the host sends a request to the processor 108 through the host interface block 106, in response to which the processor 108 reads the command from the host interface block 106 and, based on the command, sets up the data path in the channel control module 200 and stores the command in the channel control module's command register of command processor 404.

The processor 108 also translates the address from the host interface block 106 into an internal NAND address and stores it in the channel control module's address processor 406. If logical-to-physical address conversion is to be performed, the processor 108 can use a mapping table to create the correct physical address. The processor 108 can also perform one or more additional functions described below. The processor 108 then sets up a data transfer from the RAM 110 to the channel control module 200. It is noted that the memory interface block 112 can include multiple channel control modules, as shown in FIG. 5.

The channel control module 200 takes the value from the address processor 406 and formats it in accordance with the ONFi memory interface protocol format or HLNAND memory interface protocol format. The data stored in the RAM 110 is sent to the encryption processor 414 for encryption and is then sent through the data scrambler 410. The data scrambler 410 scrambles the data and outputs the scrambled data to the ECC encoder 400, which generates the ECC parity bits to be stored with the data. The data and ECC parity bits are then transferred, through the multi mode memory interface module 418 ports, with either an ONFi memory interface protocol format or an HLNAND memory interface protocol format, with the page program or write command to the memory devices for storage.

The channel control module 200 further includes an EDC processor 416 that includes an EDC encoder and an EDC decoder. The EDC processor 416 executes an Error Detection Coding algorithm for either the HLNAND or ONFi memory interface protocols. The channel control logic 408 is generally responsible for routing the processed information and data from one functional block to another, and the multi function memory interface module 418 and the bus.

In summary, the previously described functional blocks of channel control module 200 execute data processing operations on the data to be written to the memory devices, and on the data read from the memory devices independent of the memory interface protocol being used. It is noted that the channel control logic 408 can also determine when to drive control signals through the multi function memory interface module 418, such as control signals CLE, ALE, CSO and DSO for example, so that their assertions would be coordinated with specific memory operations and with the proper sequence. Accordingly, the channel control logic 408 is configured to execute algorithms specific to both HLNAND and ONFi.

The multi function memory interface module 418 is responsible for capturing the data and other information received at the single set of ports, and converting the data and the received information in any of the modes of operation, which may correspond to either of the two memory interface protocol formats, into a native memory controller format. Conversely, the multi function memory interface module 418 is responsible for providing commands, address and write data in any of the modes of operation, which may correspond to either of the two memory interface protocol formats. As only a single set of ports are available, at least one port can be assigned any one of three different functions.

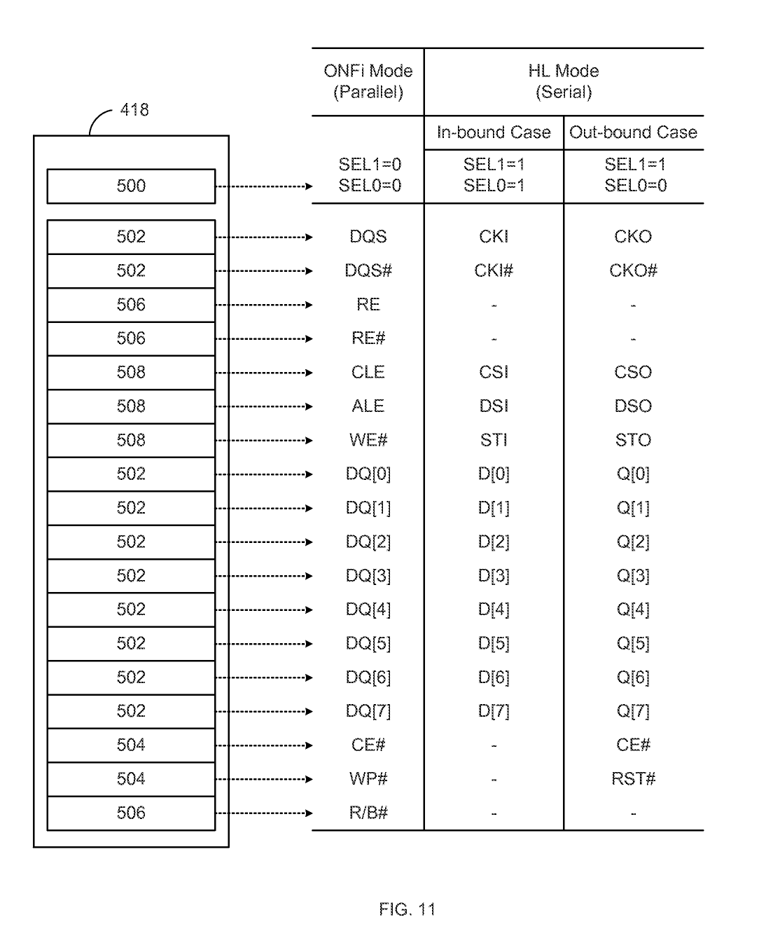

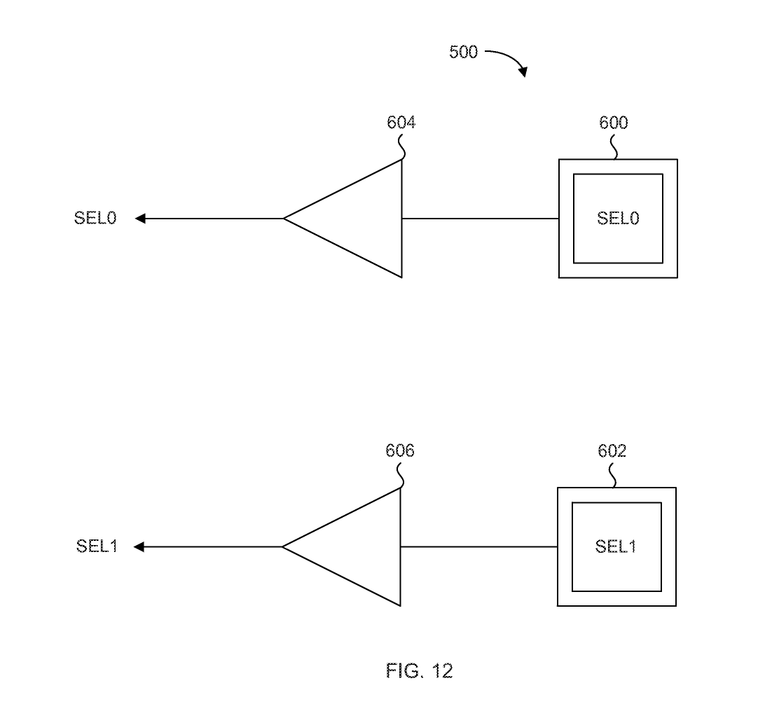

FIG. 11 is a block diagram of the multi function memory interface module 418 of FIG. 10, with multiple functional assignments for each port. According to the present embodiment, similar types of signals are mapped to the same port, wherever possible. Types of signals include control, status, data, and clock signals. Each type of signal has a corresponding type of buffer circuit connected to a pad. In the embodiment of FIG. 11, the multi function memory interface module 418 has port buffer circuits configured for three modes of operation. For example, one mode is the ONFi memory interface protocol mode, a second mode is the HLNAND memory interface protocol outbound mode, and a third mode is the HLNAND memory interface protocol inbound mode.

The multi function memory interface module 418 embodiment of FIG. 11 includes a port buffer circuit for each pad, where a pad is a metallized area of the semiconductor substrate for electrical connection to one end of a bond wire. The other end of the bond wire is connected to a physical pin of the package which encapsulates the semiconductor substrate. The multi function memory interface module 418 embodiment includes multiple port buffer circuits indicated by reference numbers 500, 502, 504 and 506. The port buffer circuit 500 is an input buffer circuit, which in the present embodiment is a multi-bit mode selector circuit. More specifically, port buffer circuit 500 includes two pads, one corresponding to SEL0 and another corresponding to SEL1. SEL0 and SEL1 are the same mode selection ports shown in FIGS. 8 and 9. As shown in the table of FIG. 11, connection of SEL0 and SEL1 to VDD (logic 1) or VSS (logic 0) selects which of the three operating modes the other port buffer circuits 502, 504, 506 and 508 are to be configured as. It is noted that some port buffer circuits can be configured to operate in up to three different modes, other port buffer circuits can be configured to operate in up to two different modes, and other port buffer circuits may only operate in one mode.

The port buffer circuits 502 and 508 are bi-directional port buffer circuits, meaning that they include driver and receiver circuits for outputting a signal and receiving a signal, respectively. The port buffer circuits 502 and 508 can operate in any one of the three modes. The difference between port buffer circuits 502 and 508 is that the port buffer circuits 502 are configured to operate bi-directionally in the ONFi memory interface protocol mode and the port buffer circuits 508 are configured to operate unidirectionally in the ONFi memory interface protocol mode. The port buffer circuits 504 are unidirectional port buffer circuits, and in particular, include only driver circuits for outputting a signal. The port buffer circuits 504 can operate in any one of two modes. The port buffer circuits 506 are also unidirectional port buffer circuits including only driver circuits, but only operate in one mode.

On the right side of multi function memory interface module 418 is a table listing the signal assignments for each port buffer circuit. The left-most column lists the ONFi memory interface protocol signals for each port buffer circuit. The middle column lists the HLNAND memory interface protocol inbound signals for the same port buffer circuits. The right-most column lists the HLNAND memory interface protocol outbound signals for the same port buffer circuits. The present example illustrates one possible multi function pinout mapping for the port buffer circuits. As shown in the table of FIG. 11, clock signals such as CKI, CKO and DQS are mapped to the same port buffer circuit 502, and control signals such as CLE, CSI and CSO are mapped to the same port buffer circuit 502. Other inbound and outbound control signals of the HLNAND memory interface protocol and a control signal of the ONFi memory interface protocol are mapped to the same port buffer circuit 502.

It is noted that the ONFi memory interface protocol uses 8 bi-directional port buffer circuits for providing and receiving data signals DQ[0] to DQ[7], while the HLNAND memory interface protocol requires 8 ports for receiving input data D[0] to D[7] and 8 ports for driving output data Q[0] to Q[7]. In the present embodiment, the same logical inbound and outbound data signals of the HLNAND memory interface protocol are mapped to the same port buffer circuit 502 as a bidirectional data signal of the ONFi memory interface protocol.

Some ports of the multi function memory interface module 418 have only two signals mapped to them. As shown in FIG. 11, the WP# and RST# output signals are mapped to port buffer circuit 504. In another example, the ONFi memory interface protocol requires individual chip enable signals CE[0] to CE[7] for enabling respective ONFi memory devices of the channel. In the HLNAND memory interface protocol, only a single common CE signal is needed to concurrently enable all memory devices. Accordingly, only one output port has mapped to it one chip enable signal (CE#) of the ONFi memory interface protocol and the chip enable signal (CE#) of the HLNAND memory interface protocol. In order to simplify FIG. 11, only one of the plurality of ONFi chip enable signals is shown. The multi function memory interface module 418 of FIG. 11 is intended to illustrate examples of how multiple signals can be assigned to the same port, and therefore may not show all the ports and signals for the ONFi and HLNAND memory interface protocols.

Some ports of the multi function memory interface module 418 may have only one signal assignment. Examples in FIG. 11 include the RE, RE# and RIB# signals of the ONFi memory interface protocol, which are mapped to port buffer circuits 506. In an alternate embodiment, there may be ports of the multi function memory interface module 418 which are assigned one signal of the HLNAND memory interface protocol. In a further alternate embodiment, there may only be an inbound and an outbound signal of the HLNAND memory interface protocol mapped to a port of the multi function memory interface module 418.

Embodiments of the port buffer circuits 500, 502, 504 and 506 are shown in the circuit schematics of FIGS. 12, 13, 14 and 15 respectively.

FIG. 12 is a circuit schematic of the mode selection circuit 500 shown in FIG. 11, according to an embodiment of the present disclosure. As will be shown in further detail later, the other port buffer circuits are configured to operate in one of up to three different modes, depending on how the mode selection circuit 500 is set.

In the embodiment of FIG. 12, pads 600 and 602 each include a metallized area on the surface of a semiconductor chip or substrate, to which connections such as gold wire bonding can be made. In the present example, pad 600 is electrically connected to one of the power supply VDD or ground VSS, and corresponds to the SEL0 input of the multi function memory interface module 418. Input receiver circuitry 604, such as an input buffer circuit by example, detects the VDD or VSS connection of pad 600 to drive an internal a select signal SEL0 to either the internal high or low logic levels. Pad 602 is electrically connected to one of the power supply VDD or ground VSS, and corresponds to the SEL1 input of the multi function memory interface module 418. Input receiver circuitry 606, such as an input buffer circuit by example, detects the VDD or VSS connection of pad 602 to drive an internal a select signal SEL1 to either the internal high or low logic levels.

In the present example, SEL1 is a higher order mode select bit that selects one of the two memory interface protocols for the port buffer circuits of multi function memory interface module 418. In particular, when SEL1 is a logic low level (0), the multi function memory controller 102 is set to operate with a first memory interface protocol, such as the ONFi memory interface protocol. When SEL1 is at a logic high level (1), the multi function memory controller 102 is set to operate with a second memory interface protocol, such as the HLNAND memory interface protocol. Accordingly, SEL0 is a lower order mode select bit that is used to select a sub-mode of the HLNAND HLNAND memory interface protocol. In particular, when SEL0 is at the logic high level, the HLNAND inbound sub-mode is selected. Otherwise, when SEL0 is at the logic low level, the HLNAND outbound sub-mode is selected. SEL0 is ignored when SEL1 is at the logic low level. Therefore, each of the other port buffer circuits of the multi function memory controller 102 is configured to receive or provide one of up to the three signals mapped to it.

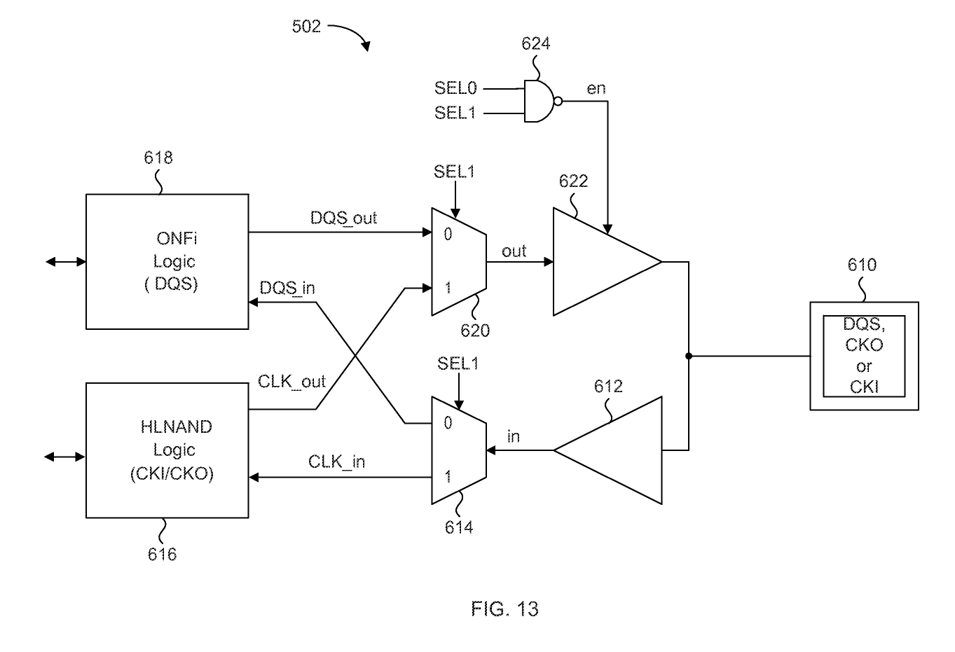

FIG. 13 is a circuit schematic of the bi-directional port buffer circuit 502 shown in FIG. 11, according to an embodiment of the present disclosure. The present example shows signals DQS, CKI and CKO mapped to port buffer circuit 502. A pad 610 can be electrically coupled to either the DQS pin of an ONFi memory device, or the CKI pin of an HLNAND compliant memory device or the CKO pin of an HLNAND compliant memory device. The buffer circuitry includes a receive path and an output path. The receive path includes a receiver 612, such as an input buffer, a selector such as demultiplexor 614, and a first logic block 616 configured for receiving a signal from one memory interface protocol, such as the HLNAND memory interface protocol, and a second logic block 618 configured for receiving a signal from another memory interface protocol such as the ONFi memory interface protocol.

The first logic block 616 is specifically configured to receive the CKI signal from pad 610 via demultiplexor 614, and may be configured to process the signal according to the requirements of the HLNAND memory interface protocol, and provides any required signals to specific circuit blocks of the channel control module 200. In particular, the HLNAND logic block 616 provides a buffered clock signal to the channel control module, and may include a delay locked loop (DLL) or a phase locked loop (PLL). The second logic block 618 receives DQS_in from the multi function memory interface module 418 and processes the signal to provide input data synchronization, in accordance with the requirements of the ONFi memory interface protocol, and provides any required signals to specific circuit blocks of the channel control module 200.

The signal received by a selector, shown as demultiplexor 614, is referred to as “in”, which can correspond to the received DQS or CKI signals at pad 610. The demultiplexor 614 is controlled by selection signal SEL1 to pass signal “in” to one of two outputs labeled “0” and “1”. In the present example, “in” is passed to the “1” output when SEL1 is at a logic level corresponding to selecting the HLNAND memory interface protocol mode. Conversely, “in” is passed to the “0” output when SEL is at a logic level corresponding to the ONFi memory interface protocol mode.

In the example of FIG. 13, SEL1 is at the low logic level for the ONFi memory interface memory protocol mode, and at the high logic level for the HLNAND memory interface protocol mode. In the HLNAND memory interface protocol mode, demultiplexor 614 provides clock signal CLK_in to logic block 616, while in the ONFi memory interface protocol mode, demultiplexor 616 provides data clock signal DQS_in to the second logic block 618.

The output path includes the first logic block 616, the second logic block 618, a selector shown as multiplexor 620 and an output driver 622. The first logic block 616 provides the output clock CLK_out for the HLNAND memory interface protocol. The second logic block 618 provides the output data clock signal DQS_out. The second logic block 618 receives signals from the other circuits of the channel control module 200, such as the multi function memory interface module 418, to generate the output data clock signal DQS_out. Similarly, the first logic block 616 receives signals from the other circuits of the channel control module 200 to generate the output clock CLK_out. Both clocks are used for data synchronization for their respective memory interface protocols.

Both DQS_out and CLK_out are provided to multiplexor 620, which is controlled by SEL1 to pass either DQS_out and CLK_out as signal “out” to the output driver 622. Hence, the output driver 622 drives pad 610 with either signal DQS_out or CLK_out based on the state of SEL1. In the present example, SEL1 at the high logic level controls multiplexor 620 to pass CLK_out while SEL1 at the low logic level controls multiplexor 620 to pass DQS_out. It is noted that output driver 622 is enabled or disabled by selection signal en provided by logic gate 624. In the present example, logic gate 624 is a NAND gate that receives SEL0 and SEL1. Therefore according to the SEL1 and SEL0 coding configuration shown in FIG. 11, the output driver is turned off when both SEL 1 and SEL0 are at logic “1” levels. As shown in FIG. 11, SEL 1 and SEL0 at logic “1” configures the port buffer circuit to operate in the HLNAND memory interface protocol inbound sub-mode. In this mode, the output driver 622 is not required and is thus disabled or turned off. Accordingly, port buffer circuit 502 is configured as an input port for receiving CLK_in.

When SEL1=0 and SEL0=0, the port buffer circuit 502 is configured as a fully bi-directional input and output port for providing DQS_out and receiving DQS_in. When SEL1=1 and SEL0=0, the port buffer circuit 502 is configured as an output port for providing CLK_out. In this mode of operation, the first logic block 616 can be configured to ignore the CLK_in signal received by demultiplexor 614 in response to the SEL0 mode selection bit. Optionally, the first logic block 616 can be enabled by one logic state of SEL1 while the second logic block 618 is disabled by the same logic state of SEL1. Thus, the first logic block 616 can be disabled by the other logic state of SEL1 while the second logic block 618 is enabled by the same logic state of SEL1. This technique allows unused logic blocks to power down, thereby conserving power.

In the embodiment of FIG. 13, the port buffer circuit 502 is configured for bi-directional DQS signals, or unidirectional CKI and CKO signals. However, a similar port buffer circuit can be employed for the other port buffer circuits labeled 502 in FIG. 11, where the main difference between them are the specific types of logic blocks 616 and 618 that would be specifically configured for processing those specific signals mapped to them.

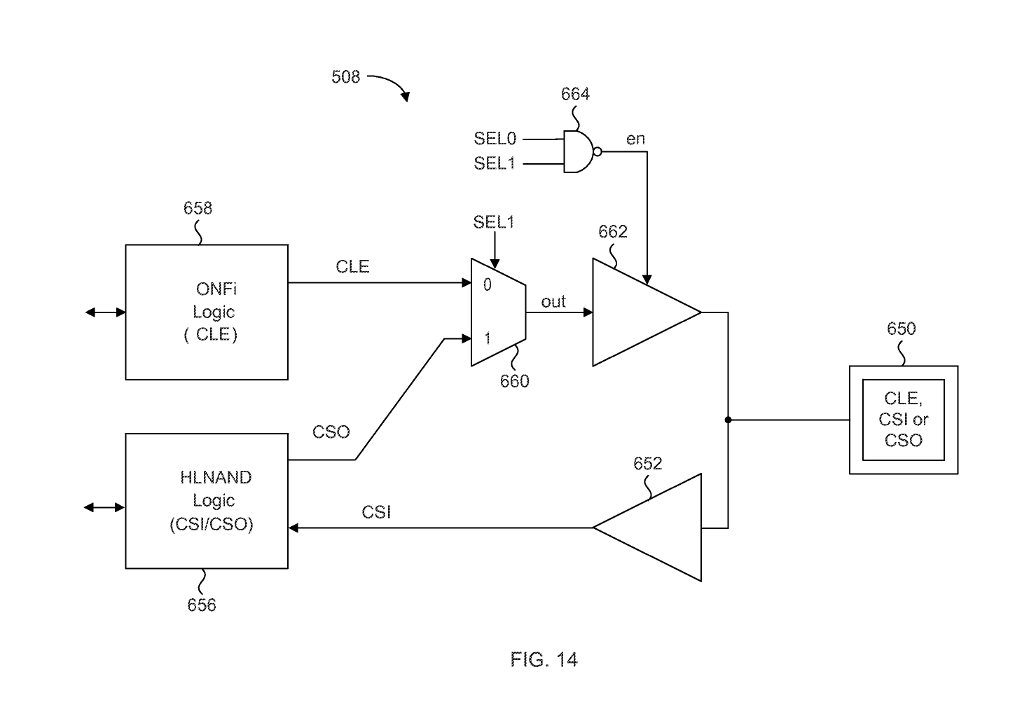

FIG. 14 is a circuit schematic of the bi-directional port buffer circuit 508 shown in FIG. 11, according to an embodiment of the present disclosure. Port buffer circuit 508 is similar to port buffer circuit 502 of FIG. 13, except that there is no demultiplexor corresponding to demultiplexor 614 in the receive path. As the components shown in FIG. 14 are similar to those of FIG. 13, an abbreviated discussion of the components of port buffer circuit 508 now follows. The present example assumes that signals CLE, CSI and CSO are mapped to the port buffer circuit 508. A pad 650 can be electrically coupled to either the CLE pin of an ONFi memory device, or the CSI pin of an HLNAND compliant memory device or the CSO pin of an HLNAND compliant memory device. The receive path includes a receiver 652, such as an input buffer, and a first logic block 656 configured to receive the CSI signal of the HLNAND memory interface protocol. The output path includes the first logic block 656 for providing the CSO signal of the HLNAND memory interface protocol, a second logic block 658 for providing the CLE signal of the ONFi memory interface protocol, selector shown as multiplexor 660 and an output driver 662. The multiplexor 660 passes either CLE or CSO to the output driver 662 in response to a state of SEL1. A logic gate 664 receives SEL0 and SEL1 to disable output driver 662 when both are at the “1” logic level to configure the port buffer circuit 508 in the HLNAND memory interface protocol inbound sub-mode. Similar to the embodiment of FIG. 13, the first and second logic blocks 656 and 658 can be enabled or disabled in response to SEL1.

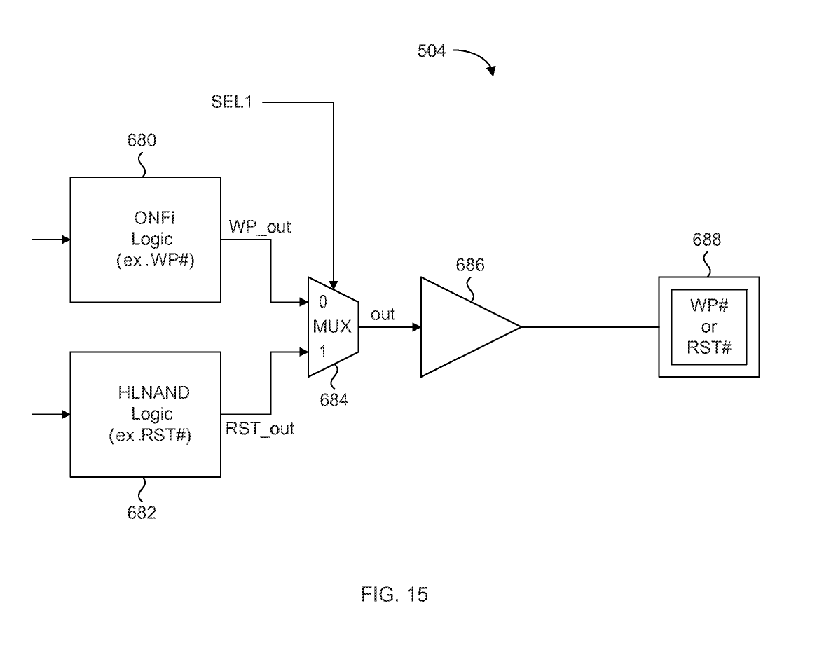

FIG. 15 is a circuit schematic of the output port buffer circuit 504 shown in FIG. 11, according to an embodiment of the present disclosure. The output port buffer circuit 504 includes a first logic block 680 configured to process a signal corresponding to a first memory interface protocol, a second logic block 682 configured to process a signal corresponding to a second memory interface protocol, a selector such as a multiplexor 684, an output driver 686, and a pad 688. In the presently shown example, the first logic block 680 is an ONFi logic block and the second logic block 682 is an HLNAND logic block. The ONFi logic block 680 receives information from the multi function memory interface module 418 for providing a read enable signal RE_out in response to other circuit blocks of the channel control module 200, which is received by the “0” input of multiplexor 684. More specifically, the ONFi logic block 680 is configured to process received signals according to requirements of the protocol, to generate the WP_out signal. The HLNAND logic block 682 provides a reset signal RST_out in response to information received from the multi function memory interface module 418, which is received by the “1” input of multiplexor 684. More specifically, the HLNAND logic block 682 is configured to process received signals according to requirements of the protocol, to generate the RST_out.

The multiplexor 684 passes one of the WP_out and RST_out as signal “out” in response to selection signal SEL1. In the present example, SEL1 at the high logic level corresponds to the HLNAND memory interface protocol mode, thereby passing RST_out to output driver 686. On the other hand, SEL1 at the low logic level corresponds to the ONFi memory interface protocol mode, thereby passing WP_out to output driver 686. As previously discussed for the other embodiments, the first and second logic blocks 680 and 682 can be enabled or disabled by SEL1. The output driver 686 then amplifies and drives its received signal onto pad 688. It is noted that both signals WP# and RST# are output signals for the ONFI and HLNAND memory interface protocols. Therefore the embodiment of FIG. 15 is an example showing how a port buffer circuit is configured to provide two different output signals.

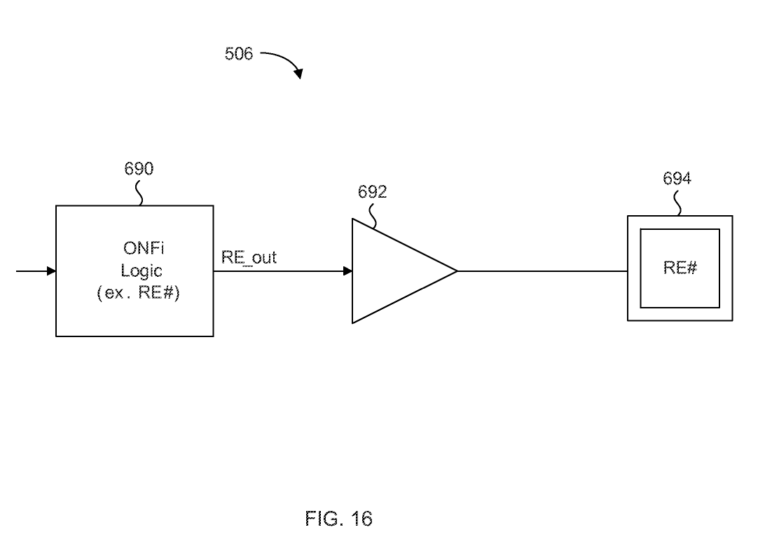

FIG. 16 is a circuit schematic of the uni-directional port buffer circuit 506 shown in FIG. 11, according to an embodiment of the present disclosure. The uni-directional port buffer circuit 506 includes an output path consisting of a logic block 690, and an output driver 692 for amplifying and driving a signal onto pad 694. In the present example, the port buffer circuit 506 is only used in one mode, that being the ONFi memory interface protocol mode for providing a read enable signal RE#. Optionally, the logic block 690 can be enabled or disabled in response to SEL1. Logic block 690 can be disabled in response to SEL1, as it is not used in either of the HLNAND memory interface protocol sub-modes.

The previously shown embodiment of FIG. 11, and the port buffer circuit embodiments of FIGS. 12 to 16 show examples of one possible pinout mapping arrangement for the multi function memory controller embodiment. Other pinout mappings are possible, provided the port the signals are mapped to is configured to receive or provide the mapped signals. The previously shown port buffer circuit embodiments can be used for mapping combinations of input, output and bi-directional signals to a single port. In any case, the signals received at the port buffer circuits are received and processed by the channel control module 200, and passed to other circuit blocks of the memory controller 102 via bus 118. Ultimately, data is provided to the host via host interface 106. Similarly, any data and commands received at host interface 106 are processed by the circuit blocks of the memory controller via bus 118, and ultimately provided to a targeted channel control module of memory interface 112, which executes the necessary protocol adaptations for signaling to the memory devices.

The previously shown embodiments illustrate how up to three signals of two memory interface protocols can be mapped to a single port of a memory controller. This allows for flexible applications of the memory controller. In alternate embodiments, each port buffer circuit can be configured to receive more than 3 different types of signals. Persons skilled in the art having understood the port buffer circuit embodiments of FIGS. 12 to 16 will understand how to scale the circuits to accommodate more than three mapped signals to each port.

The dual mode pinout memory controller embodiments can be used in any memory system, such as solid state memory systems including SSD drives and other portable memory storage devices. The dual mode pinout memory controller embodiments can further be integrated with systems that use non-volatile memory, such as in portable electronic devices including mobile phones, laptop computers and tablets by example.

In the embodiments described above, the device elements and circuits are connected to each other as shown in the figures, for the sake of simplicity. In practical applications of the present disclosure, elements, circuits, etc. may be connected directly to each other. As well, elements, circuits etc. may be connected indirectly to each other through other elements, circuits, etc., necessary for operation of devices and apparatus. Thus, in actual configuration, the circuit elements and circuits are directly or indirectly coupled with or connected to each other.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding.

The above-described embodiments are intended to be examples only. Alterations, modifications and variations can be effected to the particular embodiments by those of skill in the art without departing from the scope, which is defined solely by the claims appended hereto.

What is claimed is:

1. A multi function memory controller, comprising:
channel control modules each having at least one memory interface port including circuitry configurable to buffer a first signal compatible for communicating in a first memory interface protocol, a second signal compatible for communicating in a second memory interface protocol different than the first memory interface protocol or a third signal compatible for communicating in the second memory interface protocol; and,
a host interface having host interface ports for communicating information between a host device and the memory interface.

2. The multi function memory controller of claim 1, wherein each of the channel control modules includes
a first mode select port selectively connectible to either a first voltage or a second voltage, and
a second mode select port selectively connectible to either the first voltage or the second voltage independently of the first mode select port.

3. The multi function memory controller of claim 2, wherein the at least one memory interface port of all of the channel control modules are configured to buffer the first signal compatible for communicating in the first memory interface protocol.

4. The multi function memory controller of claim 3, wherein the first mode select port and the second mode select port are connected to a first pre-defined combination of the first voltage and the second voltage for configuring all of the channel control modules to buffer the first signal.

5. The multi function memory controller of claim 4, wherein a first channel control module is configured to buffer the second signal for communicating in the second memory interface protocol and a second channel control module is configured to buffer the third signal for communicating in the second memory protocol.

6. The multi function memory controller of claim 5, wherein the first mode select port and the second mode select port of the first channel control module are connected to a second pre-defined combination of the first voltage and the second voltage different from the first pre-defined combination.

7. The multi function memory controller of claim 6, wherein the first mode select port and the second mode select port of the second channel control module are connected to a third pre-defined combination of the first voltage and the second voltage different from the first pre-defined combination and the second pre-defined combination.

8. The multi function memory controller of claim 2, wherein a first channel control module is configured to buffer the second signal for communicating in the second memory interface protocol and a second channel control module is configured to buffer the third signal for communicating in the second memory protocol.

9. The multi function memory controller of claim 8, wherein the second signal is an outbound signal and the third signal is an inbound signal.

10. The multi function memory controller of claim 9, wherein the first channel control module is configured to buffer only outbound signals for communicating in the second memory interface protocol, and the second channel control module is configured to buffer only inbound signals for communicating in the second memory interface protocol.

11. The multi function memory controller of claim 10, wherein the first memory interface protocol is an ONFi memory interface protocol.

12. The multi function memory controller of claim 10, wherein the second memory interface protocol is an HLNAND memory interface protocol.

13. A non-volatile memory system, comprising:
a memory controller including channel control modules each having ports configurable to buffer first signals corresponding to a first memory interface protocol, second signals corresponding to a second memory interface protocol, and third signals corresponding to the second memory interface protocol; and,
a memory device operable in one of the first memory interface protocol and the second memory interface protocol in communication with one of the channel control modules.

14. The non-volatile memory system of claim 13, wherein each of the channel control modules includes
a first mode select port selectively connectible to either a first voltage or a second voltage, and
a second mode select port selectively connectible to either the first voltage or the second voltage independently of the first mode select port.

15. The non-volatile memory system of claim 13, wherein in the first memory interface protocol, the memory device includes at least two memory chips connected in parallel to the ports of a channel control module.

16. The non-volatile memory system of claim 15, wherein the first memory interface protocol is an ONFi memory interface protocol.

17. The non-volatile memory system of claim 15, wherein the second signals are outbound signals and the third signals are inbound signals.

18. The non-volatile memory system of claim 17, wherein a first channel control module is configured to buffer the outbound signals and a second channel control module is configured to buffer the inbound signals of the second memory interface protocol.

19. The non-volatile memory system of claim 18, wherein in the second memory interface protocol, the memory device includes at least two memory chips connected in series in a ring topology configuration with the first channel control module and the second channel control module.

20. The non-volatile memory system of claim 19, wherein the second memory interface protocol is an HLNAND memory interface protocol.
